(19) United States
(12) Patent Application Publication
(10) Pub. No.: US 2015/0277686 A1
(43) Pub. Date: Oct. 1, 2015

(54) Systems and Methods for the Real-Time Modification of Videos and Images Within a Social Network Format

(71) Applicant: ScStan, LLC, Costa Mesa, CA (US)

(72) Inventors: Andrew Michael LaForge, San Clemente, CA (US); Perry Michael LaForge, San Clemente, CA (US); Basil Munir Abifaker, San Diego, CA (US); Sherjil Ahmed, Irvine, CA (US)

(21) Appl. No.: 14/668,941

(22) Filed: Mar. 25, 2015

Related U.S. Application Data
(60) Provisional application No. 62/105,293, filed on Jan. 20, 2015.
(60) Provisional application No. 62/050,916, filed on Sep. 16, 2014.
(60) Provisional application No. 61/970,258, filed on Mar. 25, 2014.

(51) Int. Cl. G06F 3/0484; H04L 29/08; G06F 17/30

(52) U.S. Cl. CPC G06F 3/0484; G06F 17/30846; H04L 67/10

(57) ABSTRACT

The present specification describes an advanced image processing system which allows the recognition and modification of specific sections of an image. Operationally, at least a portion of an input image is identified based on user instructions. Pixels corresponding to the identified portion of the input image are compared with pixels corresponding to other parts of image to detect the entire section corresponding to the portion, and a new image is created that includes the detected section. The system may operate within the context of a social networking application in which users can modify pictures using sections from other images, share them with other users in the social network, and access and modify images using a virtual keyboard which can be customized for a user.

### CROSS-REFERENCE

The present specification relies on, for priority, U.S. Patent Provisional Application No. 62/105,293, filed on Jan. 20, 2015, U.S. Patent Provisional Application No. 62/050,916, filed on Sep. 16, 2014, and U.S. Patent Provisional No. 61/970,258, filed on Mar. 25, 2014, all of which are herein incorporated by reference.

### FIELD

The present specification generally relates to the field of image processing and, in particular, describes an advanced image recognition and editing system which enables selection, recognition and modification of at least a portion of an image in standalone images or video files. More specifically, some image processing steps may be executed in a social network mobile application using a customized virtual keyboard.

### BACKGROUND

There exist several systems and computer applications which are used for image recognition and modification. Some advanced tools, such as Adobe Photoshop® and Adobe Elements®, enable the users to modify images, but in a limited manner. For example, users are able to draw lines over the images and make modifications. In addition, users can change the contrast level and colors of images to change the overall look and feel of an image. The examples provided above, however, are difficult to use and require that a user spend significant amounts of time learning a program and perfecting a modified image.

Popular mobile applications, such as Instagram®, allow people to select images and apply various types of filters on them to create multiple effects. Most of these filters enable a user to change the look and feel of the image; for example, one filter in Instagram® allows for the creation of a faded image while another filter allows for the creation of a more vibrant image. All of the abovementioned filters, however, are very limited in that they only modify color combinations to change the overall look and feel of the complete image.

Most of the applications known in the prior art allow basic level modifications to an image. Further, the above applications do not allow for any modification of images in a video file.

There is a requirement for applications, particularly social network mobile applications, which can modify images in a much more advanced manner, including separating the video and image into modifiable portions and adding or removing components to or from an image in standalone image files and video files. In other words, there is a need, within social networking, of applications which enable users to perform complex image and video editing via an easy to use and intuitive interface on their mobile device.

### SUMMARY

The present specification discloses a method for advanced image processing comprising: identifying at least one portion of an input image based on user instructions; comparing pixels corresponding to the at least one portion of the input image with pixels corresponding to other portions of the input image to detect the entire section corresponding to the identified at least one portion; and, creating a new image comprising the detected section.

The new images created by the methods described in this specification may also be referred to as stickers or emojis.

Optionally, an edge detection process is used to identify start and end points of the section to be detected.

Still optionally, image resolution is normalized before processing.

The normalization may be conducted at a remote server location.

Optionally, normalization is conducted in parallel at a client device as well as at a remote server location.

The normalization may be conducted at the client device.

Optionally, the new image is stored in an image gallery located at a client device or at a remote server location. The new image may be used as a personalized emoticon while communicating with other users over internal or external platforms.

The new image may be shared with other users using an image processing system. The new image may also be shared with other users via external social networking platforms or messaging applications.

Optionally, the method further comprises superimposing the new image comprising the detected section over a similar type of section in a target image selected by the user, thus forming a modified image. Metadata related to the modified image may be stored at a remote server location for faster image processing. The metadata may comprise at least one of the following fields: name/location of target image; properties of the target image, such as size/width; name/location of the new image; properties of the new image, such as size/width; location of the new image on the target image; time stamp of creation of the modified image; name of the user who created the modified image.

Optionally, a second image is superimposed over the new image, wherein said second image acts as a watermark.

Optionally, the method further comprises tagging a user, via a user profile, with the new image; notifying the user that his profile has been tagged with the new image; storing the new image in the image gallery corresponding to said tagged user with his permission.

Various processing steps of the methods of the present specification may be executed using a computer application which comprises a virtual keyboard embedded within said computer application.

The virtual keyboard may be customized for each user such that each user can access newly updated images or stickers in his or her network through the virtual keyboard.

The present specification also discloses a computer program product configured to enable a data processing apparatus to perform operations comprising: identifying at least one portion of an input image based on user instructions; comparing pixels corresponding to the at least one portion of the input image with pixels corresponding to other portions of the input image to detect the entire section corresponding to the identified at least one portion; and, creating a new image comprising the detected section.

Optionally, the computer program product further comprises a virtual keyboard accessible to a user to execute various instructions for image processing. The virtual keyboard can be optionally customized for a user. The virtual keyboard may provide access to a gallery of images which is customized for each user. Optionally, a user can share his virtual keyboard with other users over a network.

The present specification also discloses a method for advanced image processing comprising: selecting a target image; identifying a section in the target image; selecting a new image from a gallery of images, wherein each of said new images in the gallery comprise a section which is of similar type as the identified section in the target image; and superimposing the new image over the identified section in the target image.

Various steps of the method may be executed through a computer application. Optionally, the computer application comprises a virtual keyboard which can be customized for each user. The virtual keyboard may provide access to a gallery of images which is customized for each user.

The gallery of images may comprise images related to the current location of the user device.

The present specification also discloses a method for processing video to be shared on an on-line social network, comprising: selecting a reference frame from an input video file; receiving user instructions to identify sections in said reference frame which are to be retained and/or removed from the complete video file; modifying said reference frame based on said user instructions; analyzing other frames in the video file to identify relevant frames comprising sections similar to the sections which are identified by the user in said reference frame; modifying all relevant frames based on the instructions received from the user for said reference frame; and creating a new video file comprising the modified frames, wherein said video processing is performed according to instructions input by a user via an application running on a mobile device.

The process of identifying said sections in video frames may comprise identifying at least one portion of the video frame based on user instructions and comparing pixels corresponding to the at least one portion of the video frame with pixels corresponding to other portions of the video frame to detect the entire section corresponding to the identified at least one portion.

Optionally, said reference frame comprises the first frame of the input video file.

Optionally, said video file is converted to an animated .GIF format before processing.

Still optionally, said video file is preprocessed to normalize it as per the requirement of a computer application executing the various steps of said method.

The preprocessing may comprise modifying the length of the video, modifying the frames per second in said video, modifying the resolution in said video, or modifying the format of said video.

Various steps of said method may be executed at a client device.

At least one of the steps of said method may be executed at a remote server location.

Optionally, the image section removed from various frames of said video file is replaced with a new image in all such frames. Optionally, an edge detection process is used to identify start and end points of said sections.

The new video file may be stored in an image gallery located at a client device or at a remote server location.

Optionally, the method further comprises sharing the new video file with other users of the computer application used for executing the steps of said method. Optionally, the method further comprises sharing the new video file over external social networking platforms or messaging applications.

Metadata related to the new video file may be stored at a remote server location for faster processing. The metadata may comprise at least one of the following fields: name/location of video file; properties of the video file, such as size/resolution/location/time stamp of creation/name of the user who created the modified file.

Optionally, the method further comprises providing a computer application to execute the steps of said video processing and providing a virtual keyboard embedded in said computer application. The virtual keyboard may be customized for each user and is updated based on the newly created image or video files accessible to said user. A user may share his virtual keyboard with other users. Optionally, said modified reference frame is stored in said virtual keyboard.

The present specification also discloses a method for processing video to be shared on an on-line social network, comprising: selecting a reference frame from an input video file; receiving user instructions to identify sections in said reference frame which are to be modified in the complete video file; modifying said sections in said reference frame based on said user instructions; analyzing other frames in the video file to identify relevant frames comprising sections similar to the sections which are identified by the user in said reference frame; modifying all relevant frames based on the instructions received from the user for said reference frame; and creating a new video file comprising the modified frames, wherein said video processing is performed according to instructions input by a user via an application running on a mobile device.

The present specification also discloses a method for video file processing comprising: selecting a reference frame in said input video file; receiving user instructions for identifying a specific section in said reference frame; modifying said reference frame by superimposing a new image over said identified section; analyzing other frames in the video file to identify relevant frames comprising sections similar to the specific section identified by the user in said reference frame; modifying all relevant frames by superimposing said new image on said specific sections in said relevant frames; and creating a new video file comprising the modified frames.

The process of identifying said sections in video frames may comprise identifying at least one portion of the video frame based on user instructions and comparing pixels corresponding to the at least one portion of the video frame with pixels corresponding to other portions of the video frame to detect the entire section corresponding to the identified at least one portion.

Optionally, said reference frame comprises the first frame of the input video file.

Optionally, said video file is converted to an animated .GIF format before processing.

Still optionally, said video file is preprocessed to normalize it as per the requirement of a computer application executing the various steps of said method.

The preprocessing may comprise modifying the length of the video, modifying the frames per second in said video, modifying the resolution in said video, or modifying the format of said video.

Various steps of said method may be executed at a client device.

At least one of the steps of said method may be executed at a remote server location.

Optionally, an edge detection process is used to identify start and end points of said sections.

The new video file may be stored in an image gallery located at a client device or at a remote server location.

Optionally, the method further comprises sharing the new video file with other users of the computer application used for executing the steps of said method. Optionally, the method further comprises sharing the new video file over external social networking platforms or messaging applications.

Metadata related to the new video file may be stored at a remote server location for faster processing. The metadata may comprise at least one of the following fields: name/location of video file; properties of the video file, such as size/resolution/location/time stamp of creation/name of the user who created the modified file.

Optionally, the method further comprises providing a computer application to execute the steps of said video processing and providing a virtual keyboard embedded in said computer application. The virtual keyboard may be customized for each user and is updated based on the newly created image or video files accessible to said user. A user may share his virtual keyboard with other users. Optionally, said modified reference frame is stored in said virtual keyboard.

The present specification also discloses a method for processing a video file and posting said processed video file to an on-line social network, comprising: selecting a reference frame from said video file; receiving a user instruction identifying sections in said reference frame which are to be retained or removed from the video file; modifying said reference frame based on said user instruction; analyzing a plurality of other frames in the video file to identify similar frames comprising sections similar to the sections identified by the user in said reference frame; modifying all similar frames based on the user instruction; and creating a new video file comprising the modified frames, wherein said video processing is performed according to instructions input by a user via an application running on a mobile device.

Optionally, said user instruction identifying sections in said reference frame which are to be retained or removed from the video file is performed by physically touching a portion of a screen of a mobile device, said portion of the screen being associated with pixels of the reference frame which are to be retained or removed from the video file.

Optionally, the process of analyzing the plurality of other frames in the video file to identify frames comprising sections similar to the sections identified by the user in said reference frame is performed by comparing the pixels of the reference frame which are to be retained or removed from the video file with pixels of the plurality of other frames in the video file and identifying those pixels of the plurality of other frames in the video file having similar characteristics to the pixels of the reference frame which are to be retained or removed from the video file.

Optionally, said video file comprises a plurality of frames in sequential order wherein the reference frame is a first frame in said sequential order.

Optionally, said video file is preprocessed to normalize it as per a requirement of a computer application executing said method, wherein said preprocessing comprises at least one of a) modifying a length of the video file, b) modifying a number of frames per second in said video file, c) modifying a resolution of said video file, and d) modifying a format of said video file.

Optionally, metadata related to the new video file is stored at a remote server location, wherein said metadata comprises at least one of a) a field describing a name of the new video file, b) a field describing a location of the new video file, c) a field describing properties of the new video file, d) a field describing a size of the new video file, e) a field describing a resolution of the new video file, f) a field describing a creation time stamp of the new video file, and g) a field describing a name of the user who created the new video file.

The aforementioned and other embodiments of the present invention shall be described in greater depth in the drawings and detailed description provided below.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1A is a flow chart showing exemplary steps in the creation of a new BOM image in accordance with one embodiment of the application of the present specification;

FIG. 1B is a flow chart showing exemplary steps in the creation of a new FOTOBOM image in accordance with one embodiment of the application of the present specification;

FIG. 1C is a flow chart showing exemplary steps in video object extraction in accordance with an embodiment of the application of the present specification;

FIG. 1D is a flow chart showing exemplary steps in creation of a FOTOBOM video file in accordance with an embodiment of the application of the present specification;

FIG. 2A is an exemplary input image used with the application of the present specification, in an embodiment for creation of a BOM image;

FIG. 2B in an exemplary output BOM image generated by the application of the present specification, in an embodiment;

FIG. 2C is an image of a person provided as input to the application of the present specification, in an embodiment for creation of a BOM image;

FIG. 2D is an output BOM image generated by the application of the present specification, in an embodiment;

FIG. 3 is an example of gallery of BOM images created by the application of the present specification, in an embodiment;

FIG. 4 is a base image and a FOTOBOM image created by the application of the present specification, in an embodiment;

FIG. 5 is an illustration of a base image, an intermediate image, and a final FOTOBOM image created by the application of the present specification, in an embodiment;

FIG. 6A illustrates a base image and a plurality of FOTOBOMS created by the application of the present specification, in an embodiment;

FIG. 6B is an image depicting a drag and drop feature of the application of the present specification, in an embodiment;

FIG. 7A is an illustration of an exemplary interface of a first logo/loading page of the application of the present specification, in an embodiment;

FIG. 7B is an illustration of an exemplary interface of a login page of the application of the present specification, in an embodiment;

FIG. 7C is an illustration of an exemplary interface of a registration page of the application of the present specification, in an embodiment;

FIG. 8 is an illustration of an exemplary interface of a main menu page of the application of the present specification, in an embodiment;

FIG. 9A illustrates an exemplary interface for accessing TARGET images from a STASH page of the application of the present specification, in an embodiment;

FIG. 9B illustrates an exemplary interface for accessing BOM images from a STASH page of the application of the present specification, in an embodiment;

FIG. 9C illustrates an exemplary interface for accessing FOTOBOM images from a STASH page of the application of the present specification, in an embodiment;

FIG. 9D illustrates an exemplary interface for accessing BOM images from a SECRET STASH page of the application of the present specification, in an embodiment;

FIG. 9E illustrates an exemplary interface for accessing a list of friends followed by the user in a FRIENDS page of the application of the present specification, in an embodiment;

FIG. 9F illustrates an exemplary interface for accessing a list of friends following the user in a FRIENDS page of the application of the present specification, in an embodiment;

FIG. 10A is an exemplary interface of a ‘select image source’ page of the application of the present specification, in an embodiment, wherein users can select the source for the TARGET image;

FIG. 10B is an exemplary interface of a ‘camera roll’ page of the application of the present specification, wherein users can select a TARGET image from images available from the selected image source, which in an embodiment, is a camera roll;

FIG. 10C is an exemplary interface of a BOM editor page of the application of the present specification, in an embodiment;

FIG. 10D is another exemplary interface of a BOM editor page of the application of the present specification, in an embodiment;

FIG. 10E is another exemplary interface of a BOM editor page of the application of the present specification, in an embodiment;

FIG. 11A is an exemplary interface of a ‘camera roll’ page of the application of the present specification, in an embodiment;

FIG. 11B is an exemplary interface of a FOTOBOM editor page of the application of the present specification, in an embodiment;

FIG. 11C is another exemplary interface of a FOTOBOM editor page of the application of the present specification, in an embodiment;

FIG. 11D is another exemplary interface of a FOTOBOM editor page of the application of the present specification, in an embodiment;

FIG. 11E is an exemplary interface for displaying social networks for sharing of images of the application of the present specification, in an embodiment;

FIG. 12A is an exemplary interface of a FOTOBOM editor page of the application of the present specification, in an embodiment;

FIG. 12B is another exemplary interface of a FOTOBOM editor page of the application of the present specification, in an embodiment;

FIG. 12C is yet another exemplary interface of a FOTOBOM editor page of the application of the present specification, in an embodiment;

FIG. 12D is an exemplary interface of a FOTOBOM editor page of the application of the present specification, in an embodiment, further depicting options after creation of a new FOTOBOM;

FIG. 12E is an exemplary interface of a FOTOBOM editor page of the application of the present specification, further depicting a success message to the user upon saving the FOTOBOM;

FIG. 12F is an exemplary interface of a FOTOBOM editor page of the application of the present specification, further depicting a successful sharing of the FOTOBOM;

FIG. 13A is an exemplary interface of a virtual keyboard of the application described in an embodiment of the present specification;

FIG. 13B is an exemplary interface of the virtual keyboard illustrating when an image is selected using the application described in an embodiment of the present specification;

FIG. 13C is an exemplary interface of the virtual keyboard showing when an image is copied when using the application described in an embodiment of the present specification;

FIG. 13D is another exemplary interface of the virtual keyboard of the application illustrating when a category, such as ‘LIVE’, is selected from the navigation menu in an embodiment of the present specification;

FIG. 13E is another exemplary interface of the virtual keyboard of the application illustrating when a category, such as ‘POPULAR’, is selected from the navigation menu in an embodiment of the present specification;

FIG. 14A is an exemplary interface of the virtual keyboard of the application illustrating when an image editing tool is selected from the navigation menu in accordance with an embodiment of the present specification;

FIG. 14B is another exemplary interface of the virtual keyboard of the application illustrating when an image editing tool is selected from the navigation menu in accordance with an embodiment of the present specification;

FIG. 14C is another exemplary interface of the virtual keyboard of the application illustrating when an image editing tool is selected from the navigation menu in accordance with an embodiment of the present specification;

FIG. 14D is another exemplary interface of the virtual keyboard of the application illustrating when an image editing tool is selected from the navigation menu in accordance with an embodiment of the present specification;

FIG. 14E is another exemplary interface of the virtual keyboard of the application illustrating when an image editing tool is selected from the navigation menu in accordance with an embodiment of the present specification;

FIG. 14F is another exemplary interface of the virtual keyboard of the application illustrating when an image editing tool is selected from the navigation menu in accordance with an embodiment of the present specification;

FIG. 15 is an exemplary interface of the application illustrating an alpha-numeric keyboard option selected from the navigation menu within the virtual keyboard in accordance with an embodiment of the present specification;

FIG. 16A is an exemplary interface of the application described in the present specification illustrating an option to view saved stickers selected from the navigation menu within the virtual keyboard in accordance with an embodiment;

FIG. 16B is another exemplary interface of the application described in the present specification showing an option to view saved stickers selected from the navigation menu within the virtual keyboard in accordance with an embodiment;

FIG. 17A is an exemplary interface of the application described in the present specification illustrating an option to search stickers selected from the navigation menu within the virtual keyboard in accordance with an embodiment;

FIG. 17B is another exemplary interface of the application described in the present specification showing an option to search stickers selected from the navigation menu within the virtual keyboard in accordance with an embodiment;

FIG. 18A is an exemplary interface of the application illustrating an option to create and/or modify BOM images selected from the virtual keyboard in accordance with an embodiment of the present specification;

FIG. 18B is another exemplary interface of the application illustrating an option to create and/or modify BOM images selected from the virtual keyboard in accordance with an embodiment of the present specification;

FIG. 18C is another exemplary interface of the application illustrating an option to create and/or modify BOM images selected from the virtual keyboard in accordance with an embodiment of the present specification;

FIG. 18D is an exemplary interface of the application illustrating when a BOM image is shared over a messaging application in accordance with an embodiment of the present specification;

FIG. 19A is an exemplary interface of an EXPLORE page of the application of the present specification;

FIG. 19B is an exemplary interface for showing at least one category link available from an EXPLORE page of the application of the present specification;

FIG. 19C is an exemplary interface for showing an expanded view of at least one category link available from an EXPLORE page of the application of the present specification;

FIG. 19D is an exemplary interface of a SETTINGS page of the application of the present specification;

FIG. 20A illustrates a plurality of frames from a TARGET video file prior to modification using the application described in the present specification, in an embodiment;

FIG. 20B is an exemplary interface of a FOTOBOM video frame editor page of the application of the present specification, in an embodiment;

FIG. 20C illustrates a plurality of frames from a new video file after modification using the application described in the present specification, in an embodiment;

FIG. 21 is a diagram illustrating communication flow between a user, the client application, and server applications during server side normalization in the application of the present specification;

FIG. 22 is a diagram illustrating communication flow between a user, the client application, and server applications during client and server parallel normalization in the application of the present specification; and,

FIG. 23 is a diagram illustrating communication flow between a user, the client application, and server applications during client side normalization in the application of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present specification describes a method and application for advanced image processing, preferably within the context of a social network. For purposes of this specification, a social network is an on-line community defined by a first set of data, organized into an account in a mobile application or a set of web pages, that are controlled by and defining the interests, profile, images, video, audio, or other information of a first user (collectively first user data), and a second set of data, organized into an account in a mobile application or a set of web pages, each controlled by and defining the interests, profile, images, video, audio, or other information of a second user (collectively second user data), where the first user can selectively grant to the second user access to the first user data and/or where the second user can selectively grant to the first user access to the second user data. It should be appreciated that the selective granting of data access can be applied by any number of first users by and among any number of second users. It should further be appreciated that when a first user grants to the second user access to the first user data, the first user is “connected” to the second user. A social networking application is a self-contained software programmed, typically operating on a mobile computing device, that can be used to access an on-line community, as defined above.

In an embodiment, the application enables recognition of specific sections of an image and allows performing multiple modifications/operations on those specific sections. For the purpose of having proper reference for different types of images created using methods described in the present specification, in an embodiment, images are classified into three categories as per the following nomenclature: TARGETS are photographs, graphics, stock images, or other background images which are used as the source for a BOM or FOTOBOM; BOMS are images created from specific sections of TARGETS; FOTOBOMS are new images created by superimposing one or more BOMS relative to at least one TARGET.

In some embodiments, the BOM and FOTOBOM images created using the methods described in the present specification are also referred to as stickers or emojis. One of ordinary skill in the art can appreciate that the above nomenclature is used for reference and that there are multiple ways in which the images can be referred to without departing from the spirit and scope of the present specification.

In various embodiments, the BOM and FOTOBOM images are created within the context of a social network, as defined above, via an application on a mobile device. In some embodiments, the application includes an easy to use user interface comprising a virtual keyboard incorporating icons of modified images and/or video frames to allow for quick user access.

In an embodiment, the application described in the present specification is used to select an existing TARGET image from memory or any other external source and is provided instructions to detect and highlight the specific sections of this image which are of interest to the user. For example, the TARGET image may be accessed from the memory of a mobile device, such as the internal memory of a cell phone or an SD card of said phone. The TARGET image may also be accessed from an external source, such as a social network. For example, the TARGET image may be accessed by selecting and/or downloading an image from social network applications such as Facebook®, Instagram®, Twitter®, Whatsapp®, Gtalk®, etc. In various embodiments, a user may log in to a social networking application using their login credentials, either directly through the social networking application, or through the application of the present specification, and select, with the option of saving, a TARGET image for modification. In various embodiments, selecting the TARGET image involves touching, swiping, clicking, or pressing and holding the touchscreen of the mobile device over the desired image whereupon the user is prompted with a series of options, including saving the image to local memory and copying the image. In various embodiments, a copied image may then be pasted into the application of the present specification for modification. The method of the present specification, via the above mentioned application interface, processes the TARGET image with the help of advanced algorithms to recognize and expand the sections which are of interest to the user and displays the detected sections as a final output image or BOM on the screen of a user device running the above application.

In an embodiment, the application further enables the users to perform multiple actions using the above created BOM images comprising only specific sections detected by the application. Users can store these images in a file or gallery in memory of a local device or at a remote server for later use. In an embodiment, the users can also share these pictures with other people through messaging applications and social networks. In another embodiment, the application is fully integrated with popular social networking applications and messaging applications such as Facebook®, Instagram®, Twitter®, Whatsapp®, Gtalk® etc. so that the images can be easily shared. In various embodiments, a user may log in to a social networking application using their login credentials, either directly through the social networking application, or through the application of the present specification, and upload the created BOM and/or FOTOBOM image for sharing. The uploaded images can be viewed and, using the application of the present specification, further modified by other users.

In an embodiment, the application described in the present specification is used to select an existing TARGET image from a memory or any other external source, such as a social networking application, and is provided instructions to modify the TARGET image by using a BOM image. A user creates a new BOM image or selects an existing one from an image gallery stored in local device memory or at a remote server location and provides instructions to the application to place this BOM image over a specific area on the TARGET image to create a new image, which is referred to as a FOTOBOM image, in an embodiment. In an embodiment, the application enables a user to perform multiple actions using a FOTOBOM. A user can store a FOTOBOM in image galleries on the local device memory or at a remote server location and can also share the same with other people through social networking platforms (by uploading the created images) and messaging applications integrated with the application as described in the present specification.

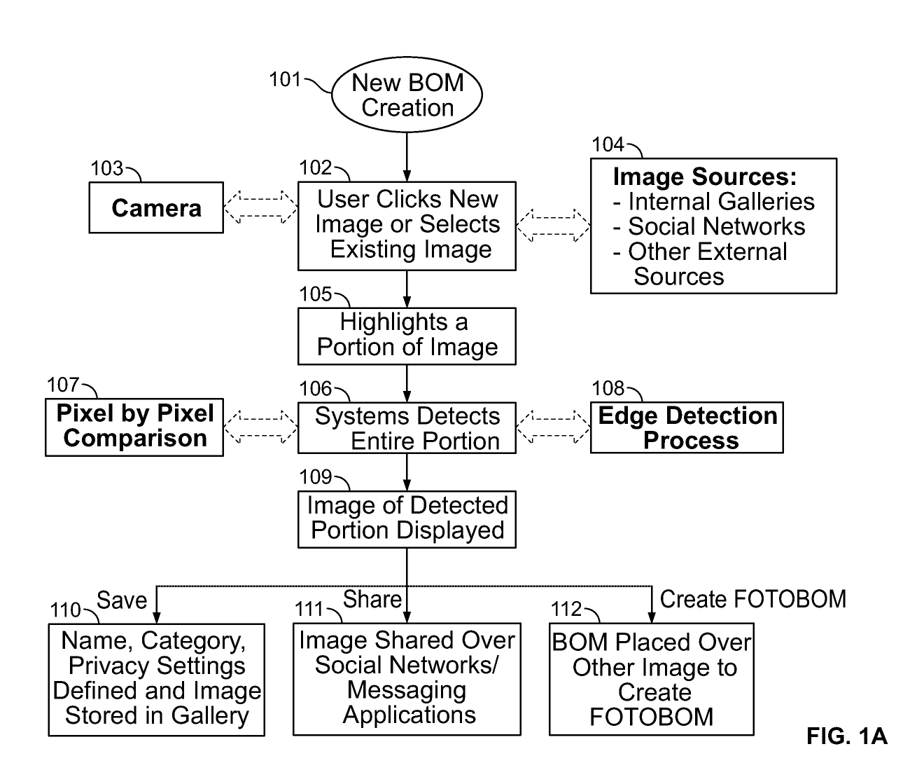

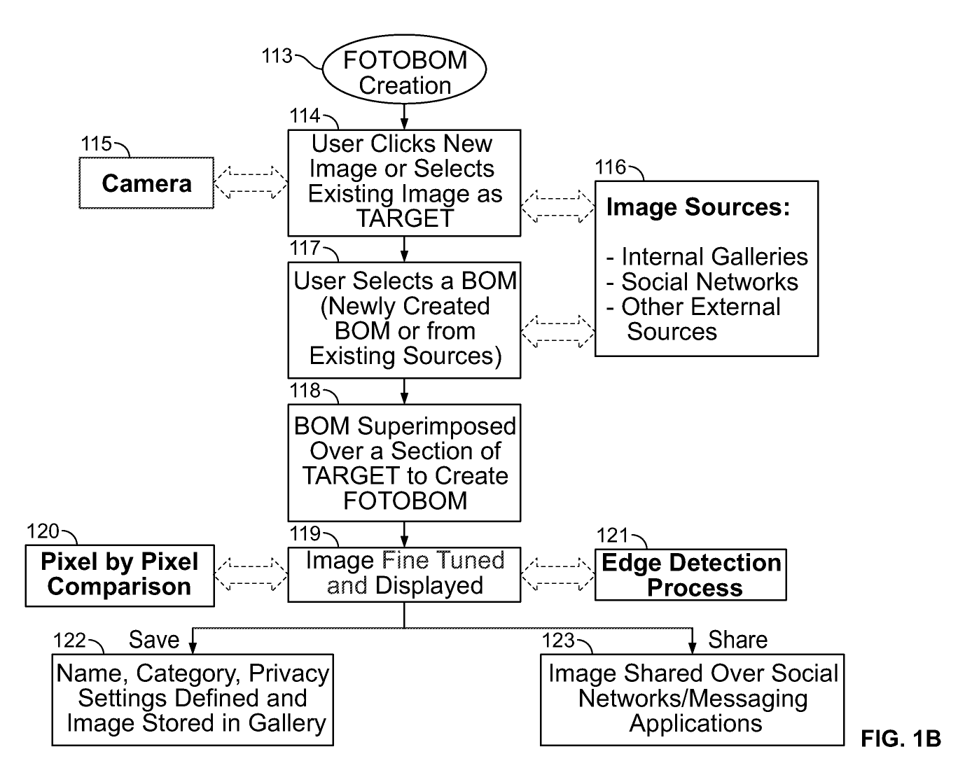

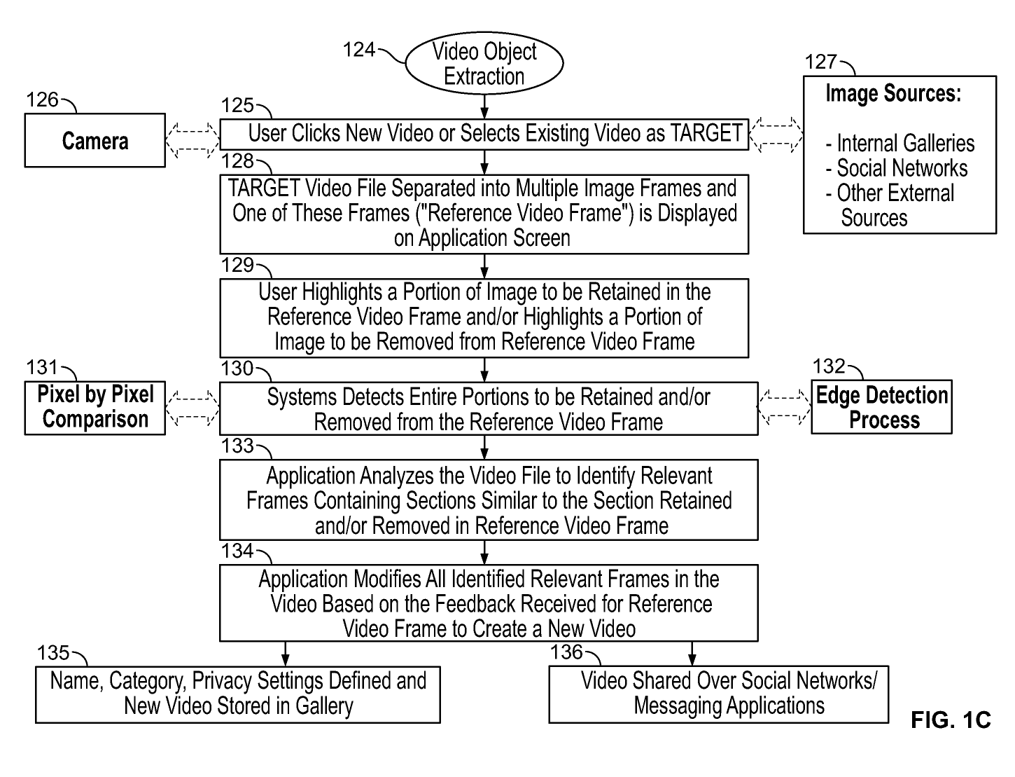

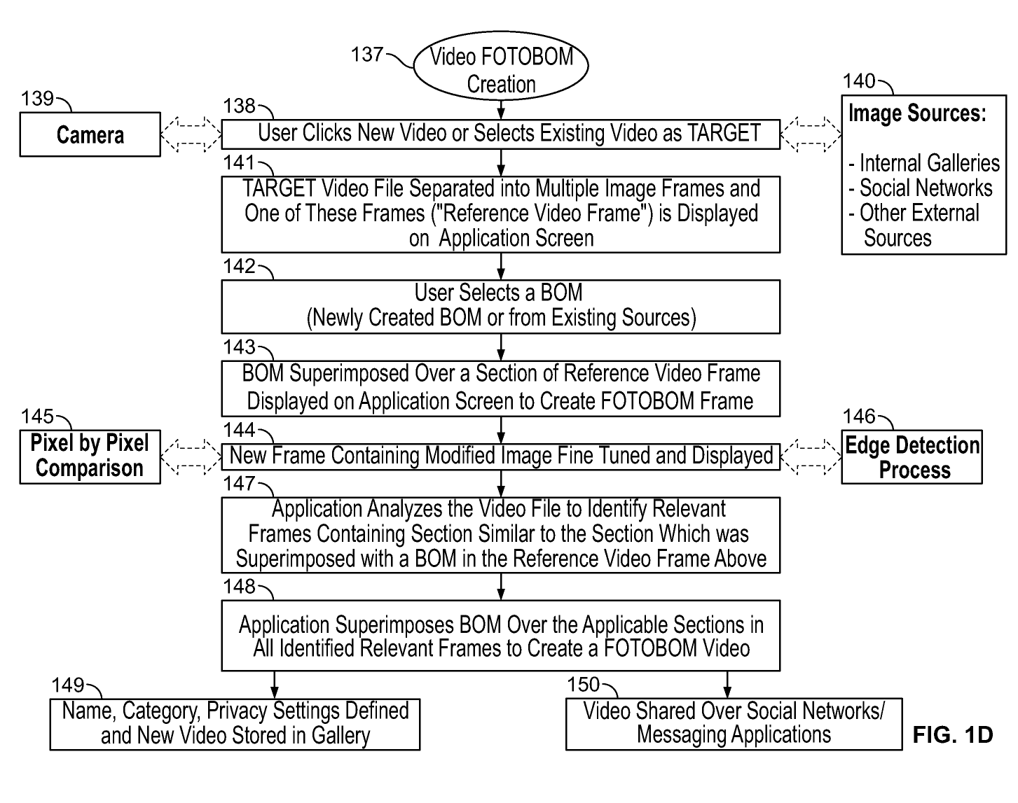

FIG. 1A is a flow chart showing steps for the creation of a BOM image as per an embodiment of the application as described in the present specification. As shown in FIG. 1A, in step 101, a user initiates the editor tool as per an embodiment of the application, which enables creation of a new BOM image. In step 102, a user shortlists a base image which is used to create a BOM. A user can either capture a new image with help of camera or can select an existing image as a base image. In case the user wants to capture a new image and use it as the base image, the same is shown in step 103 through a camera device integrated with the user device on which the application of the present specification is running. In case the user wants to use an existing image as the base image, the same is shown in step 104, where the user can select a base image from pre-existing image galleries, social networks (as described above), or other external sources. Subsequently, once a base image has been selected or captured, as shown in step 105, the user highlights a portion of the image to provide information regarding the areas of interest. In the next step 106, the application, with help of the method disclosed in the present specification, detects the entire section corresponding to the portion highlighted by the user. The method comprises advanced image processing wherein pixels corresponding to the portion highlighted by the user are compared to pixels corresponding to other regions in the image in step 107 to detect the entire section corresponding to the highlighted portion. In an embodiment, the method comprises an edge detection process to detect the start and end points of the section required in a BOM image, as shown in step 108. The application uses these advanced methods to detect the section that is of interest.

One of ordinary skill in the art can appreciate that there may be multiple embodiments through which a user can highlight a portion without departing from the spirit and scope of this invention. In an embodiment comprising a touch screen device on which the application is run, the user can touch or swipe or click a portion of the section which is of interest and application will detect the entire section using methods disclosed in the present specification. In an alternate embodiment, the application will allow the user to provide information on both the sections which are to be included in the BOM image and the sections to be removed from the BOM image. The application will accordingly process this information to detect the sections to be included in the BOM image.

In an embodiment, the application is configured to receive additional information from the user to process specific portions of an image as per the requirement. The availability of this additional information enables more accurate detection of the specific sections of the image. In an embodiment, the user provides instructions to highlight the portions of the image that comprise the border or edges of the section to be included in the BOM image. In another embodiment, the user provides instructions to apply specific filters to change the look and feel of the image. In another embodiment, the user can provide instructions to smoothen, blend, or glow specific portions in the image.

As shown in FIG. 1A, in step 109, the image of detected sections, which comprises the newly created BOM image, is displayed on the output screen of the device on which the application is running. Steps 110, 111 and 112 represent the various options/actions which the user can select to manage the newly created BOM image. In an embodiment, the application prompts the user to select one of the options so as to define how the newly BOM image is to be used. As shown in step 110, the user can save this image in a local device memory or at a remote location for future use. In another embodiment, the application provides means for the user to define a name, category, privacy settings, etc. of the BOM image before storing the same in memory. As shown in step 111, an option is presented wherein a user can share the newly created BOM image with other people through various social networking platforms such as Facebook®, Instagram®, Twitter®, Whatsapp®, Gtalk® etc. In some embodiments, sharing the BOM image on a social networking platform comprises logging into the social networking platform and uploading the created image. In an embodiment, the application disclosed in the present specification is fully integrated with these social networking platforms such that logging into the social networking platform can be accomplished through the application of the present specification. As shown in step 112, the user is presented with an option to create a FOTOBOM, by placing the newly created BOM over another TARGET image.

FIG. 1B shows a flow chart of steps related to the creation of a FOTOBOM image as per an embodiment of the application as described in the present specification. In an embodiment, a FOTOBOM is created by superimposing a BOM over any other image referred to as the TARGET image. As shown in FIG. 1B, step 113 highlights the editor/tool as per an embodiment of the application, which enables creation of a FOTOBOM image. As shown in step 114, a user first selects an image to be used as a TARGET image. In an embodiment, the user has the option, in steps 115 and 116 respectively, to either click a new image using the camera integrated with the user device or select an existing image from various image sources, such as image galleries, social networks (as described above) and other external sources. In step 117, the user subsequently also selects a BOM image to be placed over the target image. The BOM image may be a pre-existing BOM image, in which case the user will be required to select the BOM image from an image gallery, a social network, or another external source. In an embodiment, the BOM image is a newly created BOM which is already selected and hence the user will be prompted to only select a TARGET to create a FOTOBOM.

Once the user has selected both TARGET and BOM images, the user provides instructions to the application, through an application interface, regarding placement coordinates of the BOM over the TARGET. These instructions could be provided in multiple ways. In an embodiment, the user can drag the selected BOM image and drop it over the selected TARGET image at the desired location with the help of a computer key or mouse or by using the touchscreen of a touchscreen enabled device. In an embodiment, the application provides an option to the user to provide the exact coordinates of the TARGET image over which the BOM is to be placed. The user might use this option to fine tune the positioning. Generally, while creating the FOTOBOM, BOM images will be placed over that section of TARGET image which falls in the same category as the section displayed in the BOM image. For example, the BOM image might represent the face of a person and a user will generally place it over the face section of any other image. However, one of ordinary skill in the art could appreciate that the methods disclosed in this specification do not have any kind of such limitations and it is up to the creativity of a user how he wants to create combinations of BOM and TARGET images to create FOTOBOMS. In various embodiments, the application provides a library of pre-existing TARGET and BOM images falling in various categories which could be used. For example, in an embodiment, to enable creating funny characters using images of various animals, the application has a library of BOMS comprising faces of various types of animals. The users can select any of these pre-existing BOMS and place them over the face section of their friends, etc. to create funny images which could be shared over a social network with mutual friends.

Once the user provides instructions regarding placement coordinates of the BOM on the TARGET image, as shown in step 118, the BOM is superimposed over the TARGET to create a FOTOBOM. Subsequently, in step 119, the image is fine tuned as the BOM might not fit accurately over the section in the TARGET image which is to be superimposed. In an embodiment, the methods disclosed in this specification use pixel by pixel comparisons and edge detection methods as shown in steps 120 and 121 to integrate the BOM with the TARGET in a seamless manner. In an embodiment, the application might also change the dimensions of edges for seamless integration of the BOM with the TARGET. Steps 122 and 123 depict the options available to a user once the newly created FOTOBOM is ready and displayed on the screen of the user device running the application. As shown in step 122, the user has the option to store the FOTOBOM in local device memory or at a remote location and also define its properties, such as name, category, privacy settings, etc. In step 123, the user is provided with an option to share the FOTOBOM with other people over social networking platforms (by logging into the social networking platform and uploading the FOTOBOM, as described above) and messaging applications integrated with the application, as described in the present specification.

In the embodiments above, although the methods of the present specification have been disclosed in the form of an application or a computer program which can be used on any user device such as mobile phone, tablet computer, or laptop, desktop computer, etc, one of ordinary skill in the art can appreciate that there could be multiple other embodiments to practice the invention. In an embodiment, a remote server and web based interface is used to implement and practice the methods disclosed here and there is no application loaded in the user device. The user can visit the webpage to access this system.

In an embodiment, the invention as described in the present specification comprises a computer web-based application or mobile application through which a user can create an account and also interact with other users using the same application. The application acts like a social network over which the users can capture images, modify them in advanced ways described in this specification and share it over the network with other users. The user account may include basic information provided by the user, such as photographs, a brief introduction, location, a friends list, image galleries, including public and private, and security settings, among others.

The application of the present specification, in an embodiment, includes advanced tools that allow the users to click pictures, search for pictures from internal or external sources (such as social networks), name them, store them in galleries, modify them and also share the same with selected people in their social networks, etc. The users can also share the images from their account with other people through various types of external communication platforms. In an embodiment, the system is integrated with direct messaging platforms such as Gtalk®, Whatsapp®, etc. to make this process smooth and convenient. In one embodiment, the user logs in to the direct messaging platform through the application and, after creating a BOM or FOTOBOM image, is provided an option, via the application interface, to upload and share the created image via the direct messaging platform. The computer application is also integrated with social media networks such as Twitter®, Facebook®, etc. and a user can directly share the images in his wider network on these platforms. In one embodiment, the user logs in to the social media network through the application and, after creating a BOM or FOTOBOM image, is provided an option, via the application interface, to upload and share the created image via the social media network. In an embodiment, the users can search pictures from image galleries of other users on social networks and use them for further modification. In an embodiment, the user can shortlist some of the best pictures created by them and charge a fee to other users for using these images. In another embodiment, the application keeps track of all the images in any user account, and in case any image from a user's gallery is accessed by other users or shared outside over external networks, the concerned user is notified accordingly. In an embodiment, the application provides the user with the option of blocking certain images from access by other users on the social network.

In an embodiment, the users can search pictures corresponding to specific categories which might be previously stored in the system library or might be sourced from external sources in real time. The user can subsequently modify these images as per the requirement.

In an embodiment, based on the demographic profile of a user, the application automatically recommends images to the user for modification through advanced methods. For example, if the user is a teenager, the application might recommend him images of his classmates which the user might modify in advanced ways to create interesting funny images.

In an embodiment, the application allows the users to take part in various contests conducted through the system. The users are required to modify images of their classmates, coworkers, friends, etc. or images related any other given themes and submit their entry. In an embodiment, the entries submitted by users get rated by various other users and the best rated entry is declared the winner.

In an embodiment, based on the demographic profile and interests of a user, the system might show targeted advertisements to him.

In an embodiment, the application described in the present specification provides the user with the functionality of accessing or enabling a virtual keyboard within the application interface. In some embodiments, upon receiving user instruction, the native or default keyboard provided within the application can be replaced by a virtual keyboard which contains shortcuts and tools for accessing and manipulating images. In some embodiments, the virtual keyboard is customized.

In an embodiment, the customized virtual keyboard is a separate application which the users have an option to download, either separately or with the FOTOBOM application on their device. In an embodiment, users can share their customized virtual keyboard with other users in a network. In another embodiment, the virtual keyboard can be shared across other applications. In an embodiment, the virtual keyboard is a separate application which is compatible across various applications on multiple platforms such as iOS, Android, Windows, etc. and can be used across multiple applications in addition to the FOTOBOM application.

In an embodiment the images, such as BOMS and FOTOBOMS as described in the present specification, are also referred to as stickers or emojis. The virtual keyboard contains a gallery of such stickers or emojis which can be accessed by the user.

In an embodiment, the virtual keyboard described in the present specification is dynamic in nature such that the various stickers or emojis linked to the virtual keyboard of a user changes based on settings for the corresponding user. In an embodiment, the images linked to a virtual keyboard change when new images are posted or uploaded by the other users in the network. In another embodiment, the virtual keyboard is constantly populated with new images corresponding to specific themes (preselected by the user), which are posted or uploaded in the application.

In an embodiment, the application described in the present specification further provides the functionality to modify or process video files in multiple ways. In an embodiment, the application allows recognition of specific sections of an image in a plurality of frames in a video file based on the user feedback and allows performing modifications/operations on these specific sections of images in all the image frames based on the feedback received only for said plurality of image frames. In an embodiment, the application provides a very convenient feature wherein a video file is separated into multiple image frames and modifications done by the user in a single image frame are automatically applied to all image frames in which similar modifications would be applicable. In an embodiment, when a video file is selected, a first frame of a video is opened in the application described in the present specification and the user is required to input all changes required in the first frame. Once the user completes the changes in the first frame, the system automatically applies similar changes to all other relevant frames in the video file in which such changes are possible. In case the user wants to keep certain sections in an image and remove certain other sections, the user is required to highlight the sections he would want to keep or the sections he wants to remove only in the first frame. The application records the input provided by the user and, one by one, analyzes all frames to identify relevant frames containing sections similar to the sections highlighted by the user and accordingly modifies all relevant frames as per the user feedback received for the first frame.

One of ordinary skill in the art would appreciate that a user can highlight a section in an image frame for performing multiple operations, such as for removing such section from the file, for changing the size, color, contrast or brightness of that portion, for superimposing that section with some other image, or for changing some other parameter in that section. In an embodiment, once the user provides input regarding the exact change required in the highlighted section in any one single frame, the application applies the similar change to all image frames in which such a change would be applicable. In an embodiment, the application searches all frames in a video file to search for relevant frames in which such a change would be applicable. In other embodiment, the application searches for relevant frames in a sequential manner until it encounters the first frame in which such a change would not be applicable. For example, the user may provide input for the first frame to remove a certain kind of background image from the frame. In the above embodiment, the system will sequentially search all frames and remove similar background images until it encounters a frame which does not contain the similar background image.

In an embodiment, the application allows removing images of specific objects from a plurality of image frames contained in a video file as described above. FIG. 1C is a flow chart showing steps followed in such a video object extraction method as per an embodiment of the application as described in the present specification. As shown in FIG. 1C, in step 124, a user starts the editor/tool as per an embodiment of the application, which enables extraction of a video object from multiple image frames. As shown in step 125, a user first selects a video file to be used as a TARGET video. In an embodiment, the user has the option, in steps 126 and 127, to either record a new video image using the camera integrated with the user device or select an existing video from various sources such as video galleries, social networks (as described above), and other external sources. In step 128, the video file is separated into multiple image frames and one of these frames, referred herein as a Reference Video Frame, is displayed on the application screen to enable the user to modify this frame in the next steps. In one embodiment, a first frame from the video file is displayed on the application screen. In another embodiment, the user is allowed to scan multiple frames contained in the video file and select the Reference Video Frame that is displayed on the application screen. In step 129, the user highlights a portion of image to be retained in the Reference Video Frame and/or highlights a portion of image to be removed from Reference Video Frame. In the next step 130, the application, with the help of the method disclosed in the present specification, detects the entire sections corresponding to the portions highlighted by the user. The method comprises advanced image processing wherein pixels corresponding to the portions highlighted by the user are compared to pixels corresponding to other regions in the image to detect the entire sections corresponding to the highlighted portions as shown in step 131. In an embodiment, the method comprises an edge detection process to detect the start and end points of the complete sections highlighted by the user, as shown in step 132. The application uses these advanced methods to detect the sections that are of interest.

One of ordinary skill in the art can appreciate that there may be multiple embodiments through which a user can highlight a portion without departing from the spirit and scope of this invention. In an embodiment comprising a touchscreen device on which the application is running, the user can touch or swipe or click a portion of the section which is of interest and the application will detect the entire section using the methods disclosed in the present specification.

In an embodiment, the application is configured to receive additional information from the user to process specific portions of an image as per the requirement. The availability of this additional information enables more accurate detection of the specific sections of image. In an embodiment, the user provides instructions to highlight the portions of image that comprise the border or edges of the section to be retained in the Reference Video Frame. In another embodiment, the user provides instructions to apply specific filters to change the look and feel of the image. In an embodiment, the user can provide instructions to smoothen, blend, or glow specific portions in the image.

Subsequently, in step 133, the application analyzes all other image frames in the video file to identify relevant image frames containing sections similar to the sections which were retained or removed in the Reference Video Frame as described above. At step 134, the application creates a new video by modifying all such relevant frames frame by retaining or removing those sections from these frames which were retained or removed from the Reference Video Frame.

Steps 135 and 136 depict the options available to a user once the newly created video is ready and displayed on the screen of the user device running this application. As shown in step 135, the user has the option to store the new video in local device memory or at a remote location and also define its properties such as name, category, privacy settings, etc. In step 136, the user is provided with an option to share the new video with other people over social networking platforms (by logging into the social networking platform and uploading the FOTOBOM, as described above) and messaging applications integrated with the application, as described in the present specification.

In an embodiment, the user can create FOTOBOM video files similar to the FOTOBOM image files described in this specification in FIG. 1B.

FIG. 1D shows a flow chart of steps related to the creation of a FOTOBOM video as per an embodiment of the application as described in the present specification. As shown in FIG. 1D, 137 highlights the editor/tool as per an embodiment of the application, which enables creation of a FOTOBOM video file. As shown in step 138, a user first selects a video file to be used as a TARGET video. In an embodiment, the user has the option, in steps 139 and 140, to either record a new video image using the camera integrated with the user device or select an existing video from various sources such as video galleries, social networks (as described above) and other external sources. In step 141, the video file is separated into multiple image frames and one of these frames, referred herein as a Reference Video Frame, is displayed on the application screen to enable the user to modify this frame in the next steps. In one embodiment, a first frame from the video file is displayed on the application screen. In another embodiment, the user selects the Reference Video Frame to be displayed on the application screen. In step 142, the user subsequently also selects a BOM image to be placed over some specific image sections in the Reference Video Frame displayed in the application screen. The BOM image may be a pre-existing BOM image, in which case the user will be required to select the BOM image from an image gallery, a social network, or another external source. In an embodiment, the BOM image is a newly created BOM, which is already selected and hence the user will be prompted to only select a TARGET video to create a FOTOBOM.

Once the user has selected both the Reference Video Frame and BOM image, the user provides instructions to the application, through an application interface, regarding placement coordinates of the BOM over the Reference Video Frame. These instructions could be provided in multiple ways. In an embodiment, the user can drag the selected BOM image and drop it over the selected Reference Video Frame at the desired location with the help of a computer key or mouse or by using the touchscreen of a touchscreen enabled device. In an embodiment, the application provides an option to the user to provide exact coordinates of the Reference Video Frame at which the BOM is to be placed. The user might use this option to fine tune the positioning. Generally, while creating a FOTOBOM video, BOM images are placed over that section of TARGET video which falls in the same category as the section displayed in the BOM image. For example, a BOM image might represent the face of a person and a user will generally place it over the face section of a video. However, one of ordinary skill in the art could appreciate that the methods disclosed in this specification do not have any kind of such limitations and it is up to the creativity of a user how he wants to create combinations of BOM images and TARGET videos to create FOTOBOM videos.

Once the user provides instructions regarding placement coordinates of the BOM on the Reference Video Frame, as shown in step 143, the BOM is superimposed over the Reference Video Frame to create a FOTOBOM. Subsequently, in step 144, the new image frame is fine-tuned as the BOM might not fit accurately over the section in the Reference Video Frame which is to be superimposed. In an embodiment, the methods disclosed in this specification use pixel by pixel comparisons and edge detection methods as shown in steps 145 and 146 respectively, to integrate the BOM with the Reference Video Frame in a seamless manner. In an embodiment, the application might also change the dimensions of edges for seamless integration of the BOM with the Reference Video Frame. Subsequently, in step 147, the application analyzes all other image frames in the video file to identify relevant image frames containing sections similar to the sections which were superimposed with a BOM in the Reference Video Frame as described above. At step 148, the application modifies all such relevant frames based on the feedback received from the user for the single Reference Video Frame by placing the BOM image over the corresponding sections in these frames. Steps 149 and 150 depict the options available to a user once the newly created FOTOBOM video is ready and displayed on the screen of the user device running this application. As shown in step 149, the user has the option to store the FOTOBOM video in local device memory or at a remote location and also define its properties, such as name, category, privacy settings, etc. In step 150, the user is provided with an option to share the FOTOBOM video with other people over social networking platforms (by logging into the social networking platform and uploading the FOTOBOM, as described above) and messaging applications integrated with the application, as described in the present specification.

In another embodiment, the user is provided with the option to provide inputs for more than one image frame for scenarios wherein the video file is of relatively long duration and the user wants to modify multiple image sections which are not displayed together in any single image frame in the video. In such a case, the user can browse through various image frames in a video file and then select two or more image frames. Subsequently, the user is required to provide inputs for the selected image frames. In an embodiment, the application analyzes all the image frames in a video file and implements the suggestions provided by the user for the selected image frames on other image frames containing the relevant sections on which user has provided the feedback.

In some embodiments, the video file is processed at a client or user device. In another embodiment, the video file is processed at a remote server such that the video is initially uploaded to a remote server location and subsequently, after the video is processed to generate a new video file as described in FIG. 1C or FIG. 1D, the same is downloaded on the user device. In another embodiment, the video file is processed simultaneously at the client or user device and the remote server location to provide a better user experience in terms of the processing speed.

In an embodiment, based on the available bandwidth, memory and the processing power of the system running the FOTOBOM application, the size of video file that can be processed by the application is restricted. In an embodiment, the application only processes video files of length between 3-10 seconds.

In another embodiment, another tool is used to first crop the selected video file size to make it compatible with the FOTOBOM application requirement. In some embodiments, various parameters such as length, resolution, frame per seconds and other relevant parameters of the selected video are modified using this tool to preprocess the selected video file and make it compatible with the FOTOBOM application requirements.

In some embodiments, the tool used for preprocessing the video file is integrated with the FOTOBOM application.

In an embodiment, wherein the selected video file is of a different format, the video file is first converted to a format supported by the FOTOBOM application. In an embodiment, the FOTOBOM application supports only a single video format, such as an animated .GIF format, and all selected video files are first converted to the supported format before processing them using the FOTOBOM application.

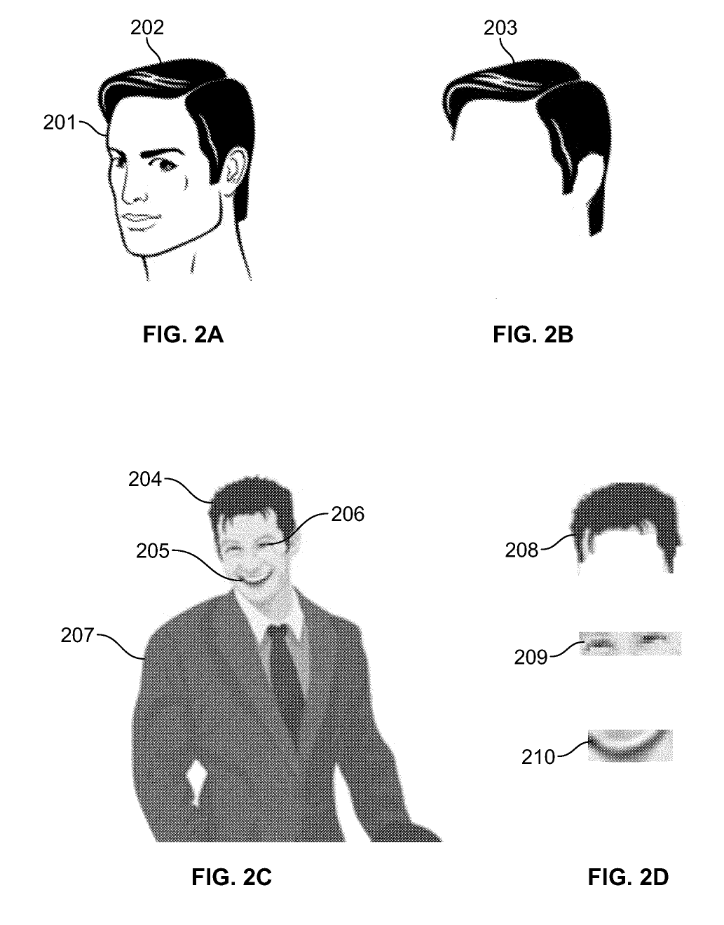

In an embodiment, the methods of the present specification are implemented in the form of an application which a user can load on his device, such as a mobile phone or computer, and start using the application. A user first selects the application, which may require a download, and then activates the application on a device. FIG. 2A illustrates an example of image processing conducted using the application and method described above. To create a new BOM image, a user first selects a base image of a person 201 from existing image libraries or from an external source. In the example shown, a user wants to create a BOM image comprising only the hair section 202 of the person 201. To provide BOM creation instructions, a user touches a screen on the device on any portion of hair 202 to select and highlight that the section representing hair 202 is required in the BOM. The user also touches the screen on areas outside of hair 202 to highlight the sections which will not be part of the BOM. In an embodiment, the user also provides instructions to highlight the edges or border of hair 202. The application processes the image and the instructions accordingly to detect the entire section comprising hair 202 and displays the same as BOM image 203 in FIG. 2B. In an embodiment, a user must highlight both sections on the image that will be a part of the BOM and sections on the image that will not be part of the BOM. In an embodiment, a user needs to only select and annotate either sections on the image that will be a part of the BOM or sections on the image that will not be part of the BOM.

In an embodiment, the application first evaluates the image pixels corresponding to the portion highlighted by the user. Subsequently, these pixels are compared with pixels corresponding to all other sections of the image on multiple parameters. After comparison, the application finds the pixels which are similar to the pixels corresponding to the area highlighted by the user to recognize the entire section representing hair 202. To fine tune the image, application further uses edge detection processes to find exact start and end points of hair section. The user can subsequently use this BOM to create a FOTOBOM or can store it or share it over the network.

In another embodiment of the application described in present specification, the user can select multiple sections/subparts to create multiple BOMS from a single base image. FIG. 2C is an illustration of a person 207 with hair 204, eyes 206 and mouth 205. The user selects this image and subsequently highlights some portions of the image, such as hair 204, eyes 206 and mouth 205 which are of interest by touching/swiping or clicking on corresponding areas in the screen. The application takes these inputs and detects the entire sections representing hair 204, eyes 206, and mouth 205 which are then displayed in separates images 208, 209 and 210 respectively, all shown in FIG. 2D. A user can subsequently save these BOMS or share them with other users through social networking platforms or can directly use them to create a FOTOBOM.

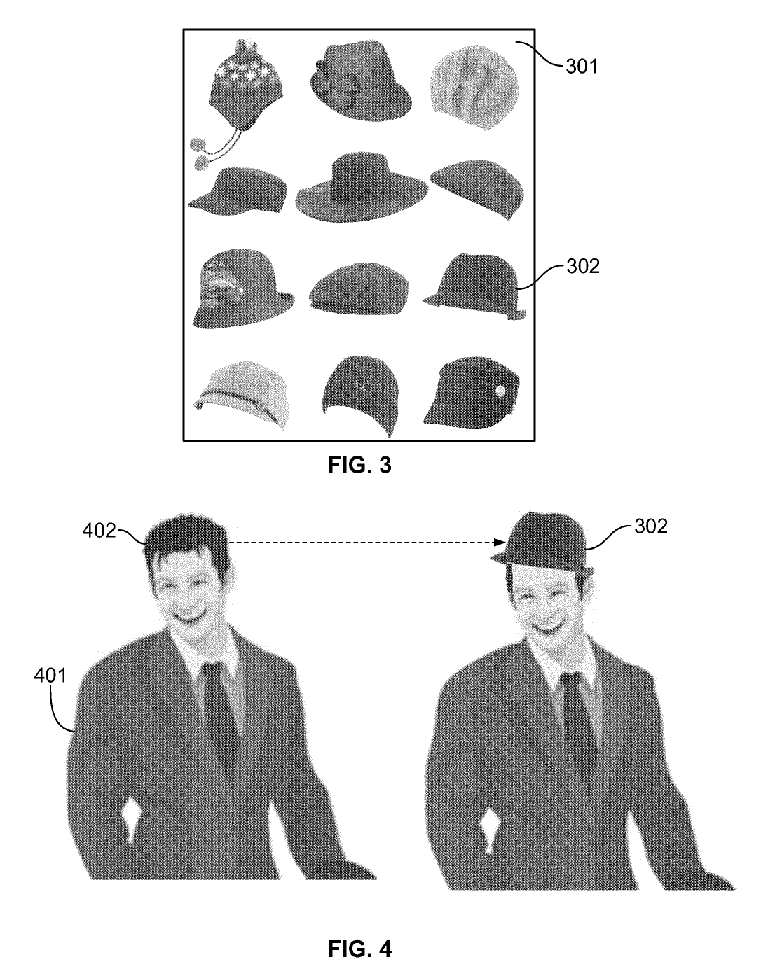

In an embodiment described in the present specification, the application allows the user to create multiple BOM images and store them in a file on the user device or at a remote server location for future use. In an embodiment, the user can create a library of specific types of BOMs (such as hats, hairstyles, or lips, etc.) in separate files for future use. FIG. 3 shows one such library 301 that contains images of multiple types of hats created by taking out the hat section from a variety of other images.

In an embodiment, the application as described in the present specification enables a user to superimpose or place the BOM image over a TARGET image selected by the user. Now referring to FIG. 3 and FIG. 4, an image of a person 401 selected by the user from an image gallery or from external sources is shown. Subsequently, the user also selects, referring back to FIG. 3, a BOM image 302 from library 301. On receiving instructions from the user, the application processes both the images and places the BOM image 302 over the hair section 402 of the TARGET image. As shown in FIG. 4, in the second image, person 401 is shown wearing a hat, which is the image represented by BOM image 302. In an embodiment, the user can drag the BOM image 302 and place it properly over the exact position required. In an embodiment, the application enables the user to define exact coordinates of the TARGET image at which the BOM will be placed. In an embodiment, the application as described in the present specification uses pixel by pixel comparison and edge detection processes to seamlessly integrate the BOM with the TARGET image.

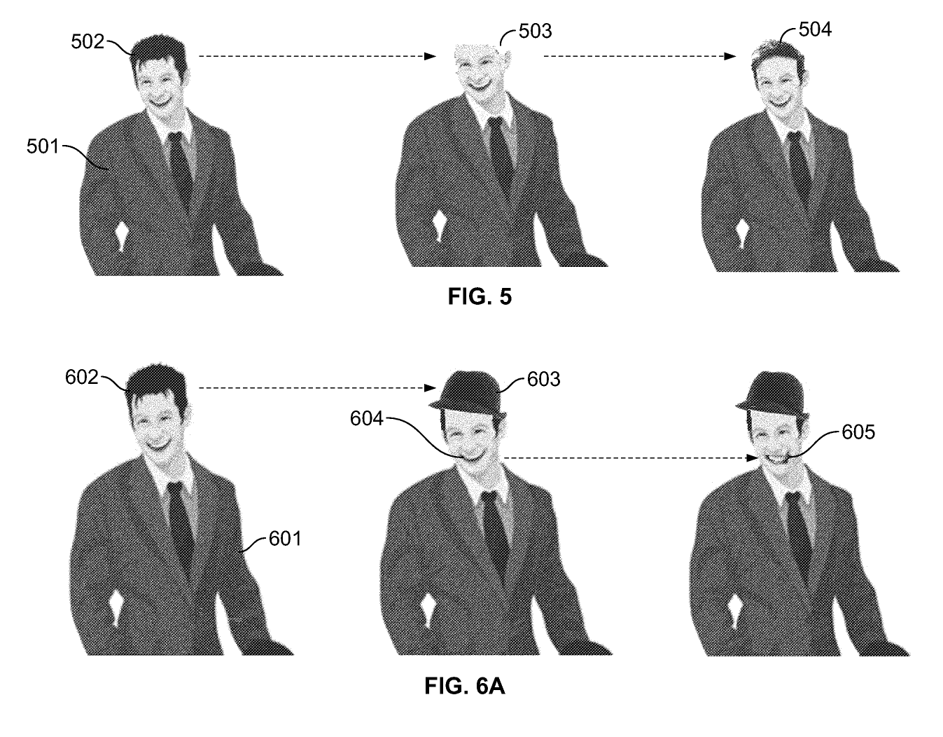

In an embodiment, on receiving instructions from the user, the application can detect the entire section of the TARGET image which is to be covered by the BOM image and can remove this section before placing a BOM over it. Now referring to FIG. 5, an image of a person 501 with hair image section 502 is shown. Upon receiving user instruction to do so, the application detects the entire hair section 502 and removes the same. The second image shown in FIG. 5 depicts the person 501 without any hair, as depicted by blank space 503. Subsequently, the user can select an appropriate BOM from the image library or can create a new BOM to be placed over the person 501 as shown in the second image in FIG. 5. On receiving appropriate instructions, the application of the present specification superimposes the selected BOM 504 over this image to create the FOTOBOM as shown in the third image of person 501 in FIG. 5.

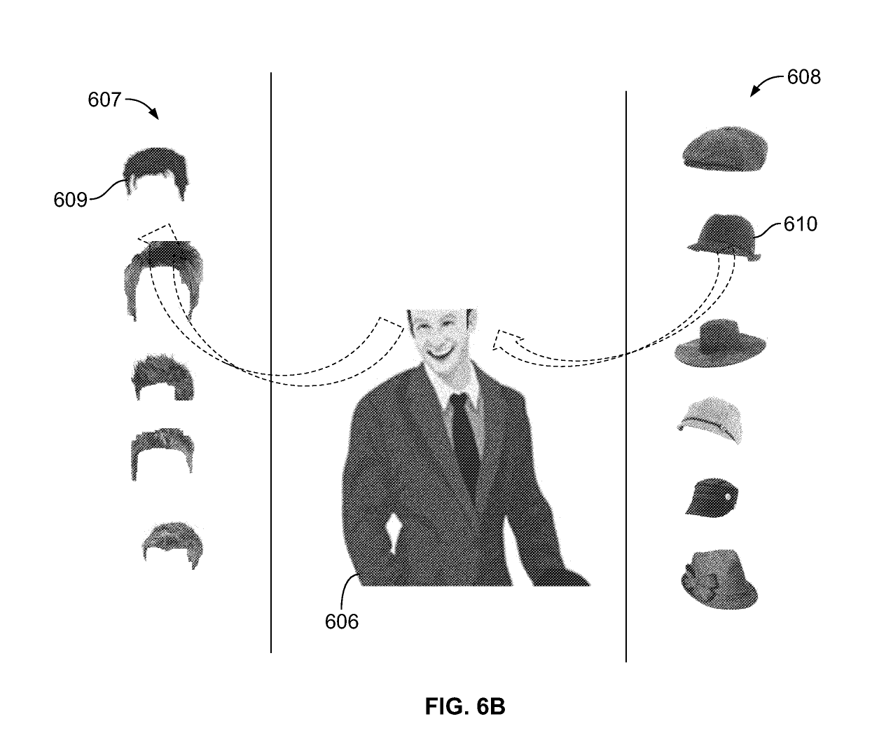

FIG. 6A depicts another example of the embodiment described with respect to FIG. 5. The user captures the image 601 with help of a camera or selects it from a previously stored location. Subsequently the user touches or swipes or clicks on any area in the sections representing hair 602 and mouth 604 in the image 601. The application as described in the present specification takes these inputs and uses advanced processing algorithms to identify and detect the entire sections corresponding to hair 602 and mouth 604. Subsequently, the user selects alternate images from a previously stored location or an alternate source to replace or superimpose these alternate images on the sections corresponding to hair 602 and mouth 604. As shown in FIG. 6A, the middle image depicts the person with its hair 602 replaced with a hat 603 and the right most image depicts the person with its mouth 604 also replaced with an alternate image of mouth 605. In an embodiment, the application disclosed herein enables the user to save any newly created BOM or FOTOBOM image in memory or share it over social networks with other people.

In another embodiment, a user can drag and drop alternate images from a digital list or library to simultaneously remove cropped sections and replace the cropped sections in any image. FIG. 6B explains this embodiment in detail. As shown in FIG. 6B, there are two BOM libraries 607 and 608 respectively. Library 607 corresponds to BOM images of various types of hair styles and library 608 corresponds to BOM images of various types of hats. A user selects an image 606 from an existing gallery of images, social network, or other external source or captures a new image with the help of a camera. Subsequently, the user touches/highlights some area in the hair section of image 606 so that the system can detect the entire hair section. The user drags the detected hair section 609 and drops it into the library 607 or deletes the same if he does not wants to save it for future use. Subsequently, the user selects image of BOM 610 from library 608 and drags and drops the same over the space vacated by hair section 609 in image 606. The application further allows the user to erase/modify parts of image 610 to fine tune the same without affecting the background image 606.

In some of the above embodiments, when a user highlights or touches a section of image to generate a target image of that specific section, the application recognizes all pixels associated with that section to detect the entire section and allows the user to replace or modify it in a plurality of ways. The application described in the present specification uses advanced processing techniques to modify images instead of merely applying color filters. A pixel by pixel comparison and boundary detection are conducted to determine where the highlighted section exactly begins and where it ends so that entire image sections could be lifted and modified in advanced ways. In an embodiment, the application uses a gradient based approach wherein the differences in values of pixels corresponding to different portions of the image are analyzed to detect different sections and corresponding edges in an image.

In another embodiment, the application receives three inputs: a source image on which various editing operations are to be performed, sections of the source image that are of interest to the user (referred to here as Keep_data), and sections of the source image that are not of interest to the user (referred to here as Remove_data). The user touches/swipes or clicks on specific portions of the source image to identify the sections corresponding to Keep_data and Remove_data. The system expands the above mentioned sections (Remove_data and Keep_data) through pixel by pixel comparison to generate the complete sections which are to be removed from or inserted into the final target image. In another embodiment, the user also provides information to identify the portions that comprise the border sections. In an embodiment, the user also provides information on sections which are to be blended or smoothed. The system accordingly uses this information to generate a more accurate image of the sections which are to be included in final image.

In an embodiment, the system first expands the Remove_data section to generate the entire section which has to be removed from the final target image. This process first detects the edges by calculating the gradients of the image. These gradients are then mapped to a 0-255 range to create a grayscale image. The user input Remove_data is mapped onto this grayscale image and this Remove_data section is then expanded by recursively checking the neighbors. If the gradient value of the neighbor is less than a preset number such as 5, the neighboring pixel is added to the Remove_data section. This process is repeatedly performed until no further pixels can be added. The removed section generated by expanding the Remove_data is subsequently used for generation of a target image corresponding to the Keep_data section.

The system expands the Keep_data section to generate the entire section which will be part of a target image. This process first detects the edges by calculating the gradients of the image. These gradients are then mapped to a −10-255 range to create a grayscale image. The user input Keep_data is mapped onto this grayscale image and this Keep_data section is then expanded by recursively checking the neighbors. If the gradient value of the neighbor is less than a pre-set number, such as but not limited to 5, the neighboring pixel is added to the Keep_data section. This process is repeatedly performed until no further pixels can be added. During the search and expansion of the Keep_data section, the algorithm checks each pixel to be excluded from the Remove_data section to ensure that Keep_data section does not merge into the Remove_data section. After the generation and expansion of the Keep_data section, the Keep_data section is returned to the user as the target image.

One of ordinary skill in the art can appreciate that the thresholds for defining the “similar” pixels vary based on the images and detection of Keep_data or Remove_data sections.

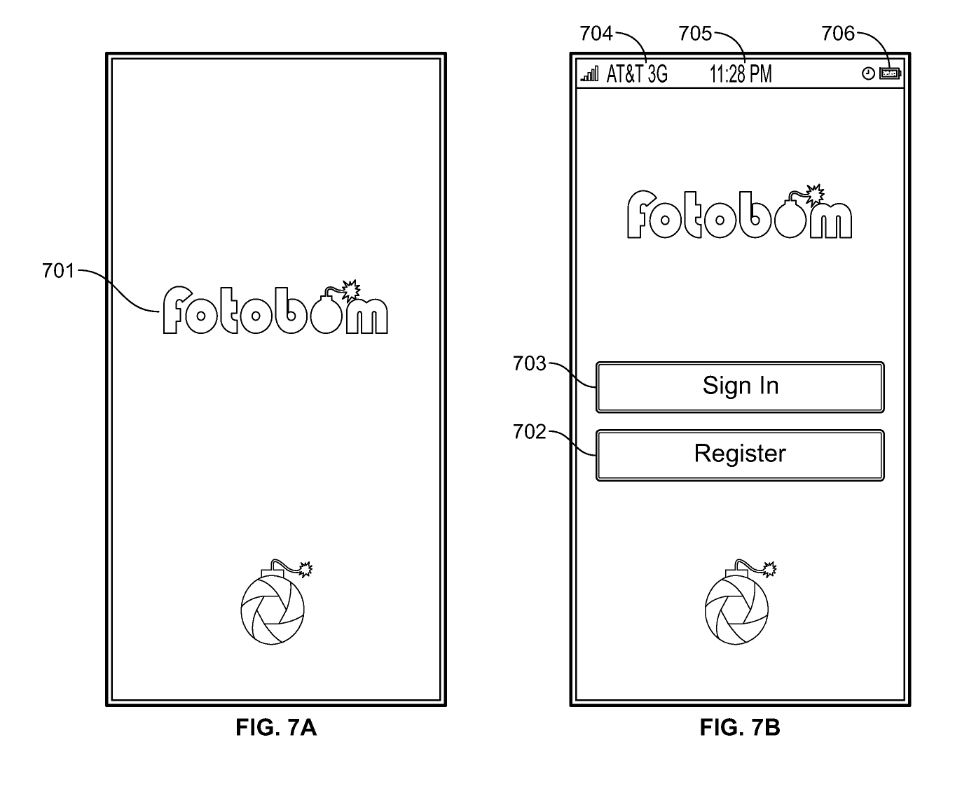

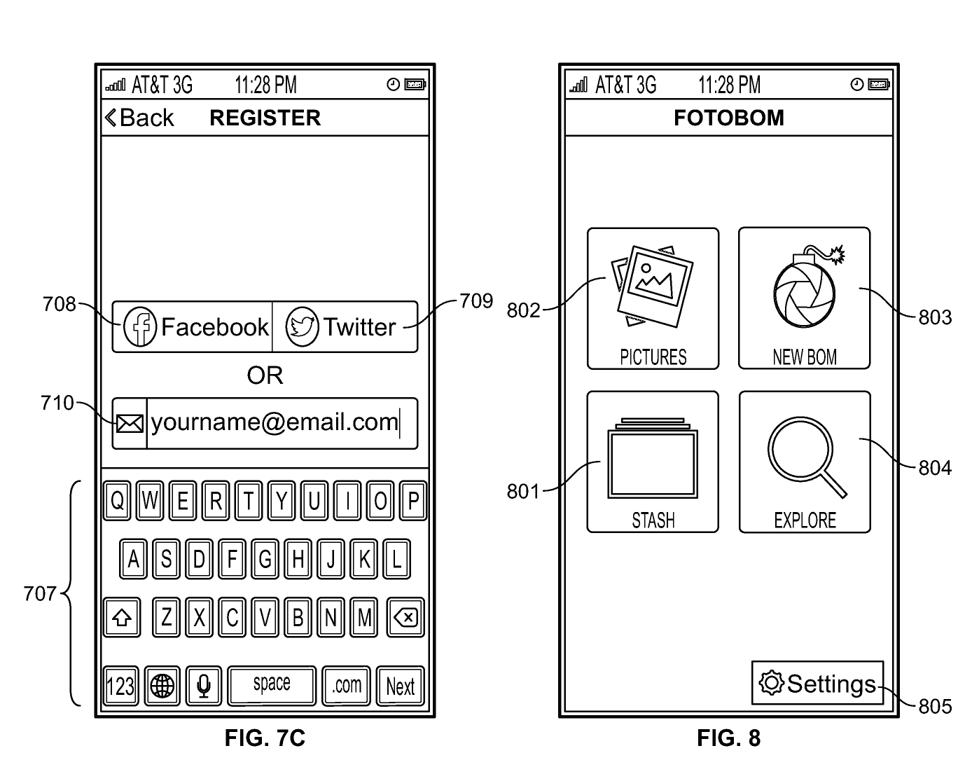

In an embodiment, the present specification describes a mobile/computer application which can be used to perform all the operations described above. The user can download the application on their mobile devices and/or computing platforms. FIG. 7A is an illustration of an exemplary interface of a first logo/landing page of the above mentioned application, in an embodiment. In FIG. 7A, icon 701 corresponds to a button “FOTOBOM” shown on the front page. A user can click on the button “FOTOBOM” to activate the application. Once activated, the application requires the user to initially create a user account and subsequently verify his or her credentials each time for accessing the system.

FIG. 7B represents an illustration of an exemplary interface of a login page of the above application, in an embodiment. As shown in FIG. 7B, 702 and 703 represent two options through which a user can start using the application. A registered user can select option 703 and provide his username and password to launch the application. A new user will be required to select option 702 through which he will be directed to a new page wherein he can provide his basic details to register on the application. In an embodiment, the application is used on a mobile device and accordingly 704, 705 and 706 represent the network connection name (and signal strength) corresponding to the mobile device, the current time, and battery usage details of the device, respectively.

In the case where a user selects options 702, he is directed to a new page shown in FIG. 7C that illustrates an exemplary interface of a registration page of the application, in an embodiment. In FIG. 7C, buttons 708 or 709, when selected, provide an option to quickly register on the application by linking the FOTOBOM account with a user's account on other commonly used social networking platforms such as Facebook® and Twitter®, respectively. In another embodiment, the application described in the present specification also includes options to register using other networking platforms such as, but not limited to, Instagram®, etc. The user can provide login credentials corresponding to any of these platforms and the FOTOBOM application provides access to the user after verifying the credentials through that external platform. In one embodiment, when registering in this manner, the user's FOTOBOM account will automatically be integrated with the social networking platform and the user will be able to seamlessly share created BOMS and FOTOBOMS by directly uploading them to the social networking platform. Input area 710 represents an option wherein a user can provide his email ID and some other details to create a new account. Keypad 707 shows the keys on a touchscreen mobile device or a computer through which a user can provide these details.

FIG. 8 is an illustration of an exemplary interface of a main menu page of the application of the present specification, in an embodiment. After a user logs into the application, he is directed to the main menu page illustrated in FIG. 8. Icon 801 represents a “STASH” button which corresponds to the home page of a user. It contains basic information about the user (which other users in his network may also see depending on the security settings) and some image galleries of TARGETS, BOMS and FOTOBOMS saved by the user. Icon 802 represents the button “PICTURES” which, when selected, allows access to various sources from where a user can select an image for processing. Icon 803 represents a button “NEW BOM” which, when selected, enables the user to access a software editor or tool for creating new BOMS or cropped images by modifying other images. Icon 804 represents an “EXPLORE” button which, when selected, allows the user to explore images corresponding to various types of themes (such as animals, children, etc.) or images stored by other users in their STASH, depending on the security settings of those users. Icon 805 represents a settings button which allows the user to access account settings and modify the same.

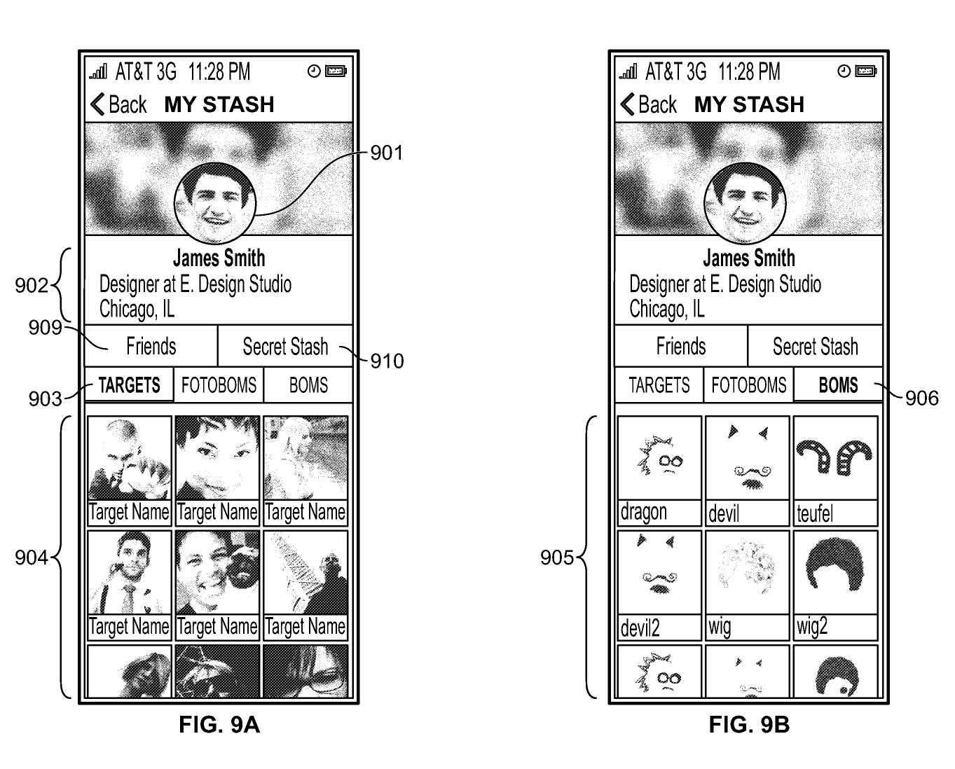

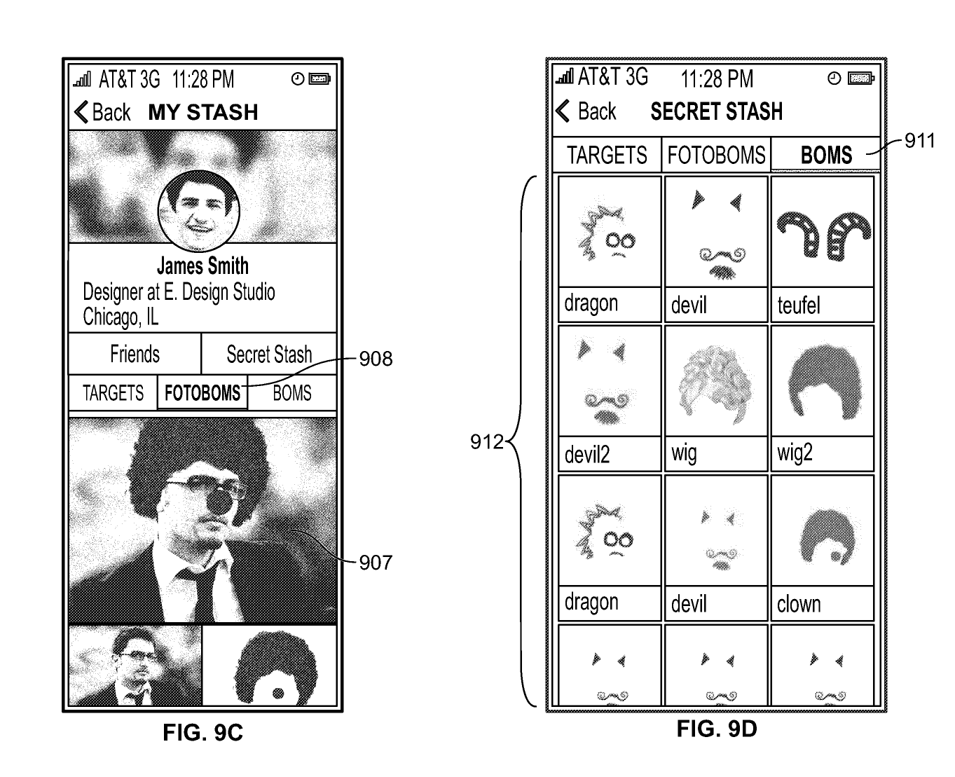

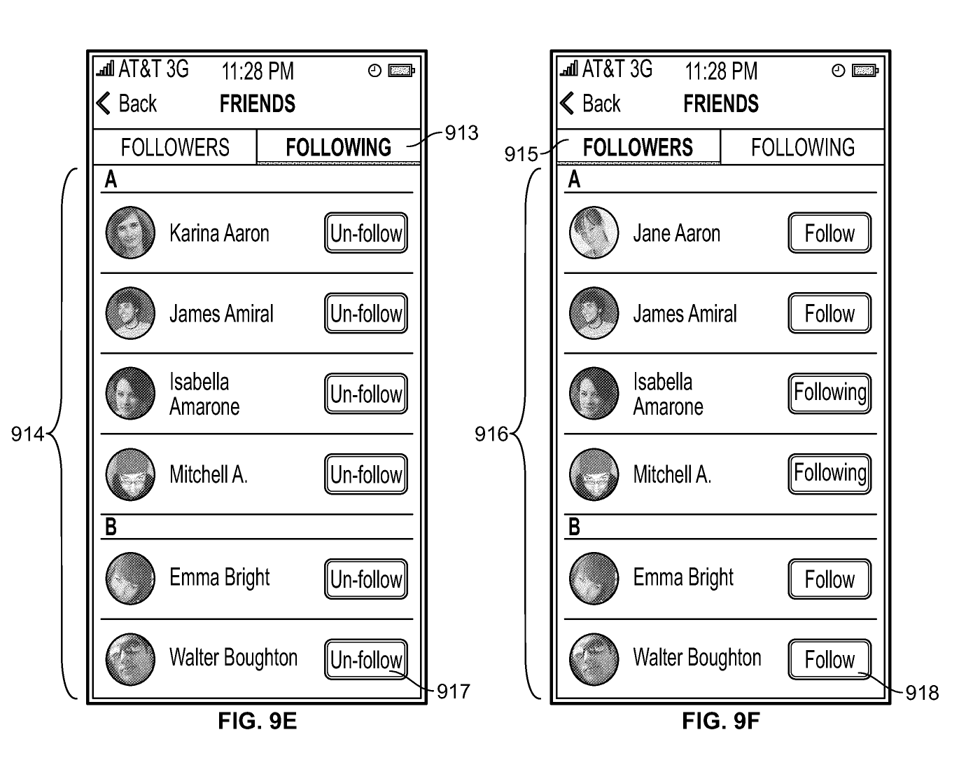

FIGS. 9A, 9B and 9C illustrate exemplary interfaces for accessing TARGET images, BOM images and FOTOBOM images, respectively, from a STASH page of the application of the present specification, in an embodiment. In FIG. 9A, area 901 represents a user's profile image. Area 902 is used to display information such as, but not limited to, the name and location of the user. Buttons 903, 906 and 908 represent menu tabs for accessing TARGETS, BOMS and FOTOBOMS, respectively, which can be selected to display the images corresponding to that category in the lower portion of the STASH page. FIG. 9A illustrates the case when button 903, which represents “TARGETS” is selected, and accordingly area 904 is used to display an assortment of pictures which may be used as base images over which to place BOMS and create FOTOBOMS. FIG. 9B illustrates the case when button 906, which represents “BOMS” is selected, and accordingly area 905 is used to display various images which may be used as BOMS to create FOTOBOMS. FIG. 9C illustrates the case when button 908, which represents FOTOBOMS, is selected and accordingly area 907 is used to display a FOTOBOM image previously created and stored by the user.

Button 909 is used to display, when selected, a list of the user's friends and details corresponding to those friends. Button 910, when selected, is used to display a “Secret Stash” page, which, in an embodiment, is a collection of BOMS, FOTOBOMS and TARGETS that can only be seen by the user and are not shared with any other user on that user's FOTOBOM network.

FIG. 9D illustrates an exemplary interface of the SECRET STASH page of the application of the present specification, in an embodiment. It contains a collection of BOMS, TARGETS and FOTOBOMS, only visible to the user. As shown in FIG. 9D, when the BOMS category is selected using button 911, the collection of BOMS stored in the secret stash of a user is displayed in area 912, which is the lower portion of the secret stash screen. A user can also select categories “TARGETS” and “FOTOBOMS” in the secret stash and accordingly the corresponding collection of images will be shown in area 912.

FIG. 9E illustrates an exemplary interface for accessing a list of friends followed by the user in a FRIENDS page of the application of the present specification, in an embodiment. On selecting the button 909 in FIG. 9A, described above, the user is redirected to a screen, as shown in FIG. 9E. Now referring to FIG. 9E, upon selection of button 913, a list of friends that the user follows is displayed in area 914.

FIG. 9F illustrates an exemplary interface for accessing a list of friends following the user in a FRIENDS page of the application of the present specification, in an embodiment. Now referring to FIG. 9F, upon selection of button 915, a list of friends that follow the user is shown in area 916. In an embodiment, when one user is followed by another user, the user who is following is able to see various updates to the image galleries of the user he is following, depending on the security settings of that user. The user can choose to unfollow or follow any user by selecting buttons 917 or 918 shown in FIG. 9E and FIG. 9F respectively. In an embodiment, when a user follows a friend, that friend is automatically cross-linked to that user so that they follow one another.

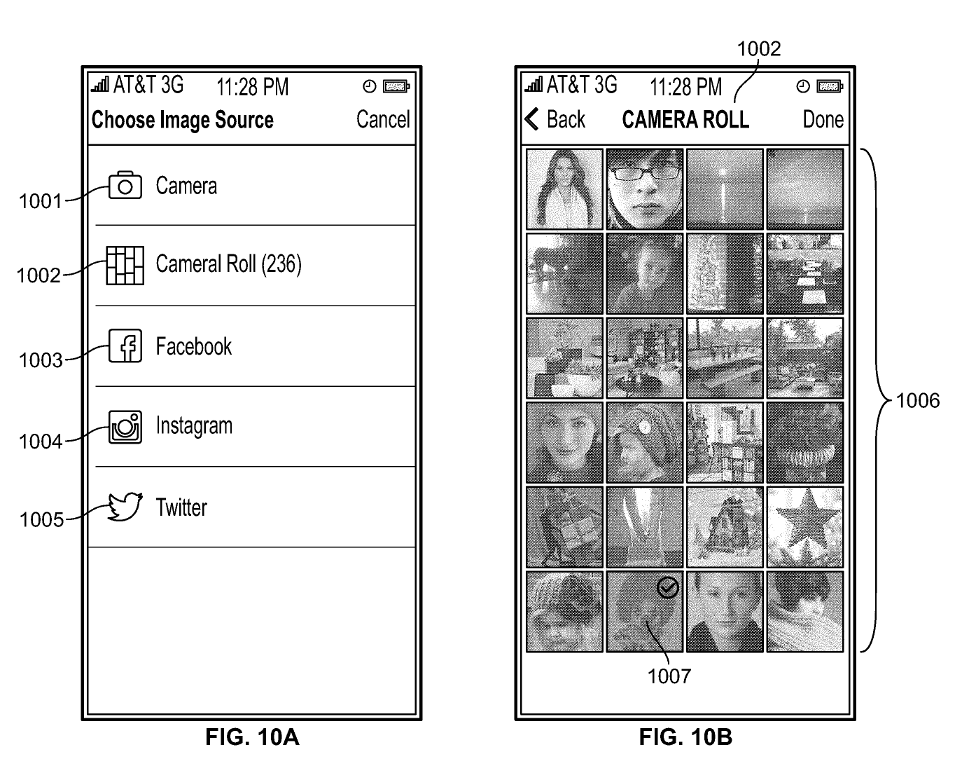

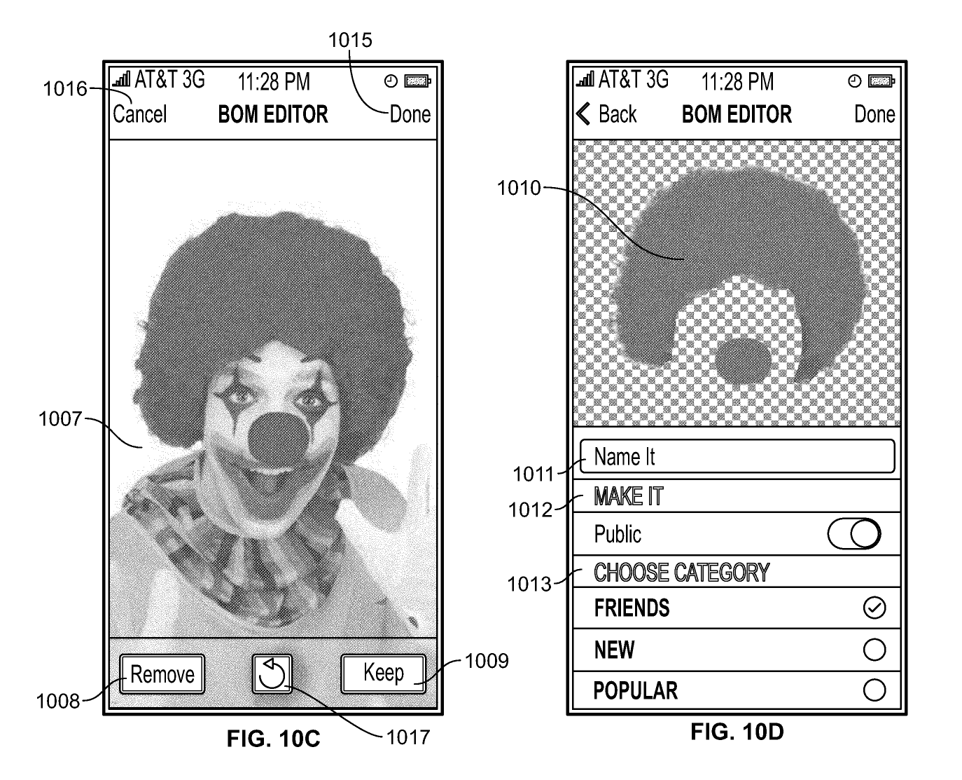

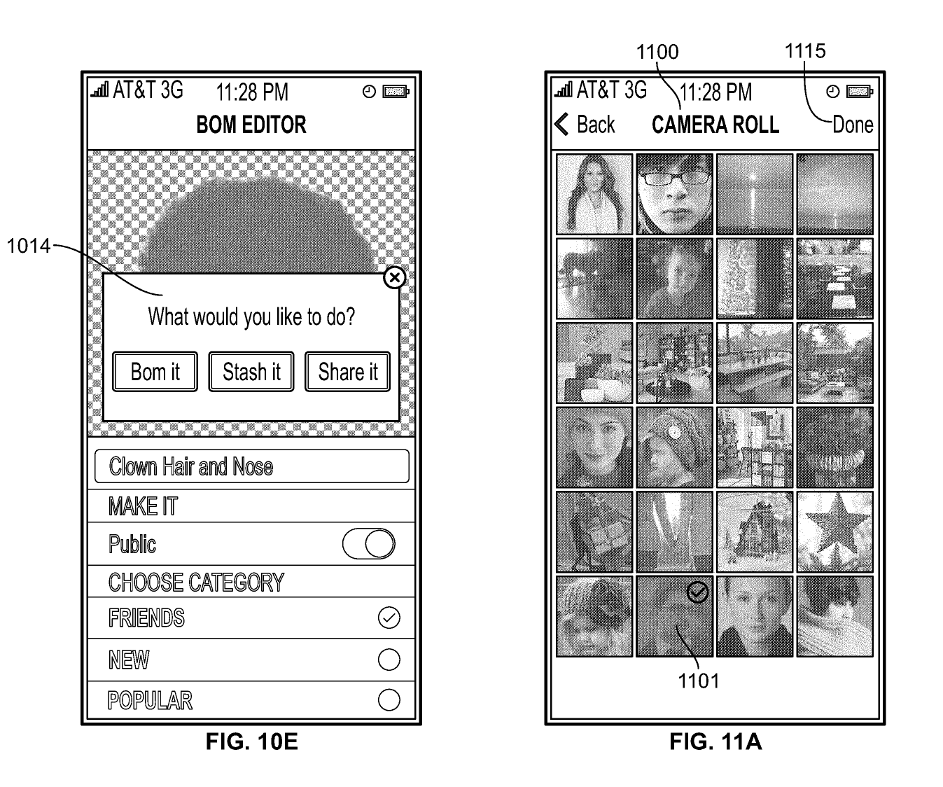

In an embodiment, to create a new BOM image, a user first selects a background image from available sources, including, but not limited to, local and remote image galleries and social networking platforms. In an embodiment, when a user selects the button “NEW BOM” corresponding to icon 803 from main menu shown in FIG. 8, the application redirects the user to a new screen, shown in FIG. 10A, which illustrates an exemplary interface of a ‘Choose Image Source’ page of the application of the present specification, wherein a user can select the source for the TARGET image. In an embodiment, the available sources include a camera 1001, a camera roll or image gallery 1002 stored on the user device or a remote server, and social media platforms such as Facebook® 1003, Instagram® 1004, or Twitter® 1005. When a user selects any of the above options, he is directed to that specific source to capture or choose a picture which could be used to create a new BOM. In an embodiment, the camera 1001 corresponds to a camera device integrated into the user device such as a mobile phone camera. One of ordinary skill in the art would appreciate that the above embodiments are just few specific examples of the user interfaces and various tools embedded in the application and there could be multiple other ways in which the above application or user interfaces could be created without departing from the spirit and scope of this invention.

In an embodiment, when the user selects camera roll 1002 in FIG. 10A, he is directed to a new screen shown in FIG. 10B. FIG. 10B is an exemplary interface of a ‘camera roll’ page of the application of the present specification, wherein users can select a TARGET image from images available from the selected image source, which in this example, is a camera roll. The camera roll 1002 contains a collection of images 1006 previously stored by the user. Image 1007 is shown highlighted as it has been selected by the user from this collection for further processing.

When the user selects image 1007, the application is redirected to the screen shown in FIG. 10C, which illustrates an exemplary interface of a BOM editor page of the application of the present specification, in an embodiment. FIG. 10C shows the BOM editor with selected image 1007. Buttons 1008 and 1009, corresponding to “REMOVE” and “KEEP”, respectively, are used to modify the image 1007 to create a new BOM. In an embodiment, selection of buttons 1008 and 1009 launches a highlight tool that allows a user to highlight portions of an image. To highlight those sections which are of interest, the user first selects or presses keep button 1009. Subsequently the user highlights the portions which are of interest and the application fills these portions with a first color. To highlight the sections which are not of interest, the user selects or presses remove button 1008. Subsequently, the user highlights the portions which are not of interest and the system fills these portions with a second color. In an embodiment, the first color is green, which depicts the portions of image to be included in the BOM, and the second color is red, which depicts the portions of image to be excluded from the BOM. If at any time the user wants to undo the previous command, the same can be done by pressing the button 1017 which undoes the last command. After providing all information, the user selects the “Done” button 1015, which signals the application that scanning is complete. The application subsequently generates a new image by keeping those sections identified in green and removing those sections identified by red, and depicting the new BOM created by the user. It should be understood by those of ordinary skill in the art that the use of colors to differentiate areas is by way of example only and that any demarcation may be used to differentiate these areas.

The above embodiment describes one specific method through which a user can highlight areas of image the user wants to keep or remove in a BOM, however one can appreciate that there could be multiple ways in which the system can take instructions from the user. In an embodiment, the user can touch or swipe or click on a portion of the section which is to be included in the image and the system conducts a pixel by pixel comparison of this portion with other areas in the image to detect the entire section corresponding to this portion.

In an embodiment, the application described in the present specification is configured to receive additional instructions from the user for more accurate detection of images. In an embodiment, the BOM editor tool screen in FIG. 10C comprises additional functions or buttons such as “BORDER”, “SMOOTHEN”, and “GLOW”. When the user selects the button “BORDER”, any subsequent portion highlighted by the user is filled with a brown color to highlight the borders or edges in an image. When the user selects the buttons “SMOOTHEN” or “GLOW”, any subsequent portion highlighted by the user is colored in a yellow color or orange color respectively, to highlight the portions of image which requires smoothening or which are to be shown with a higher level of glow or brightness. Once the user has provided all information, the application uses the above information for more accurate detection of images. One of ordinary skill in the art can appreciate that while specific colors have been used in this embodiment corresponding to various functions, in an embodiment, other color combinations could be used without departing from the spirit and scope of the present specification. Also, one can appreciate that in embodiments of the present specification, other additional buttons or functions can be provided to identify specific types of portions in an image.

In the example shown, the user creates a BOM comprising the hat and nose sections of image 1007 in FIG. 10C. FIG. 10D is an exemplary interface of the BOM editor page showing new BOM 1010 created by the application described in the present specification. The user then names the new BOM and selects the privacy setting and category, among other attributes by using, in an embodiment, input areas and/or buttons 1011, 1012 and 1013, respectively. In an embodiment, once the new BOM is created, the application provides various options such as to stash/save the new BOM in memory, or share it with others, or to BOM it over other images to create a new FOTOBOM. FIG. 10E shows an exemplary interface of the BOM editor page with 1014 representing the various options provided to the user, in an embodiment. At any time during the editing procedure, a user can cancel the process by selecting button 1016 shown in FIG. 10C.

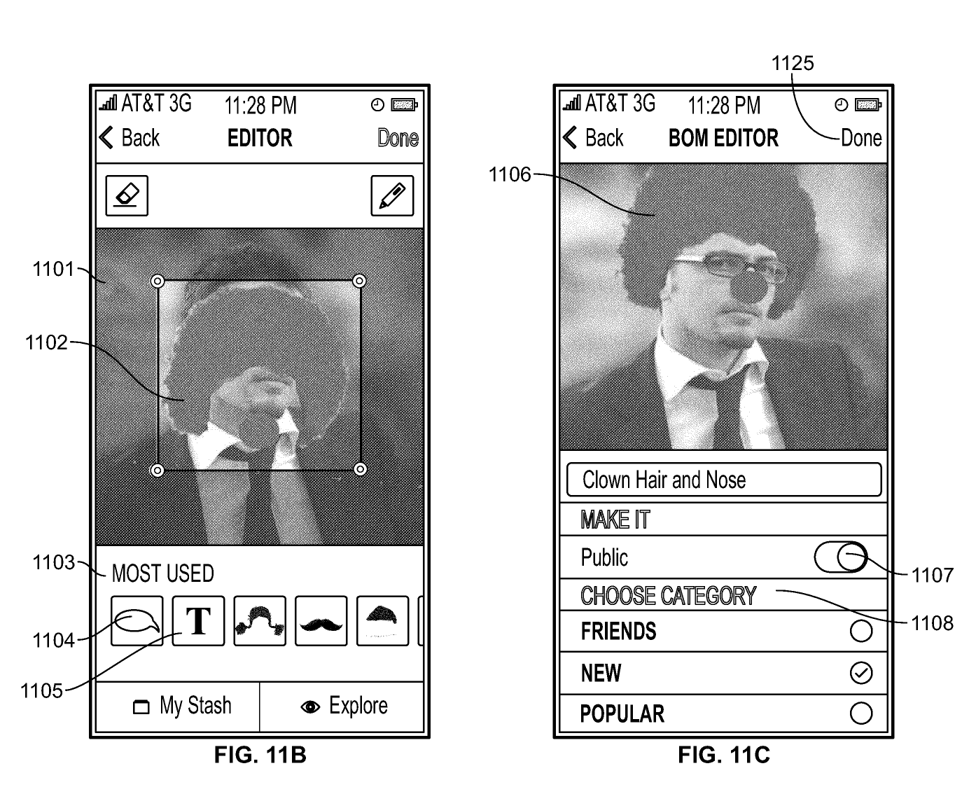

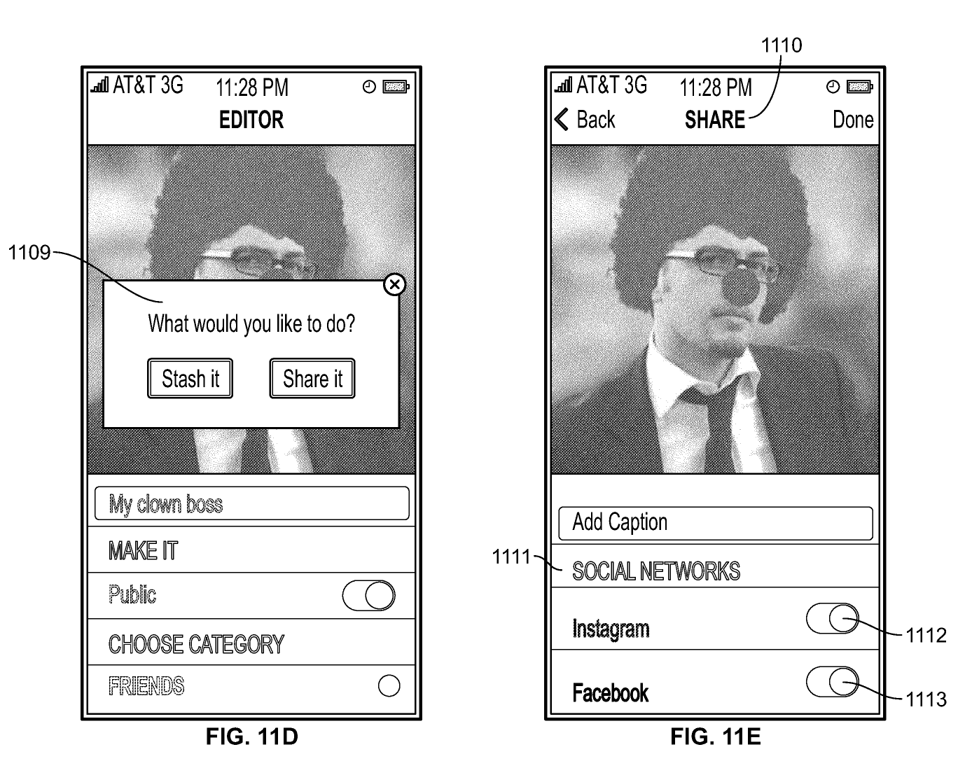

In the above embodiment, if the user chooses the option “BOM it” in 1014, he is redirected back to the screen shown in FIG. 10A to choose the source for selecting the image which will be “BOM'ed” with the BOM 1010. In an embodiment, when the user selects camera roll as the source, he is redirected to the screen shown in FIG. 11A, which illustrates another exemplary interface of a ‘camera roll’ 1100 page of the application of the present specification. As shown in FIG. 11A, 1101 represents an image that is selected by the user to be BOM′ed. Once the user presses “Done” button 1115 in FIG. 11A, the application redirects the user to a new screen shown in FIG. 11B, that represents an exemplary interface of a FOTOBOM editor page of the application of the present specification. As shown in FIG. 11B, BOM 1102 is placed over the image 1101 selected by the user to create a new image which is referred to in this application as a FOTOBOM. Scrolling area 1103 is used to display the most frequently used BOMS such as BOMS 1104 and 1105.

FIG. 11C represents another exemplary interface of a FOTOBOM editor page of the application of the present specification, showing the FOTOBOM created using the interfaces of FIGS. 11A and 11B. In FIG. 11C, 1106 is the resultant FOTOBOM image, while button 1107 is used to set privacy settings. Button 1108 is used to define a category for the new FOTOBOM. In the above example, as shown in FIG. 11C, the security setting has been selected as “Public” and the category has been chosen as “New”. In this embodiment, a user also has the option to define different levels of security settings and share the image with a specific set of people. The user can define a new category for new images or can classify the image under any existing category of images.

Once the user has completed the FOTOBOM, he selects button 1125 in FIG. 11C and the application directs him to pop-up window 1109, as shown in FIG. 11D, which is used to display options provided to the user to either save/stash the FOTOBOM in his account or share it with other users. If the user chooses to share the FOTOBOM, he is redirected to a new screen shown in FIG. 11E that illustrates an exemplary interface for displaying social networks for sharing of images of the application of the present specification, in an embodiment. In FIG. 11E, tool 1110 is used to share newly created or previously stored FOTOBOMS with other users using the FOTOBOM application and/or an external networking platforms. Area 1111 is used to display a list of various other social media networks such as Facebook® and Instagram® on which the FOTOBOM 1106 may be shared in addition to sharing with users on the FOTOBOM network. Referring to the embodiment of FIG. 11E, the user may press buttons 1112 and/or 1113 to share the FOTOBOM on Instagram® and Facebook® respectively.

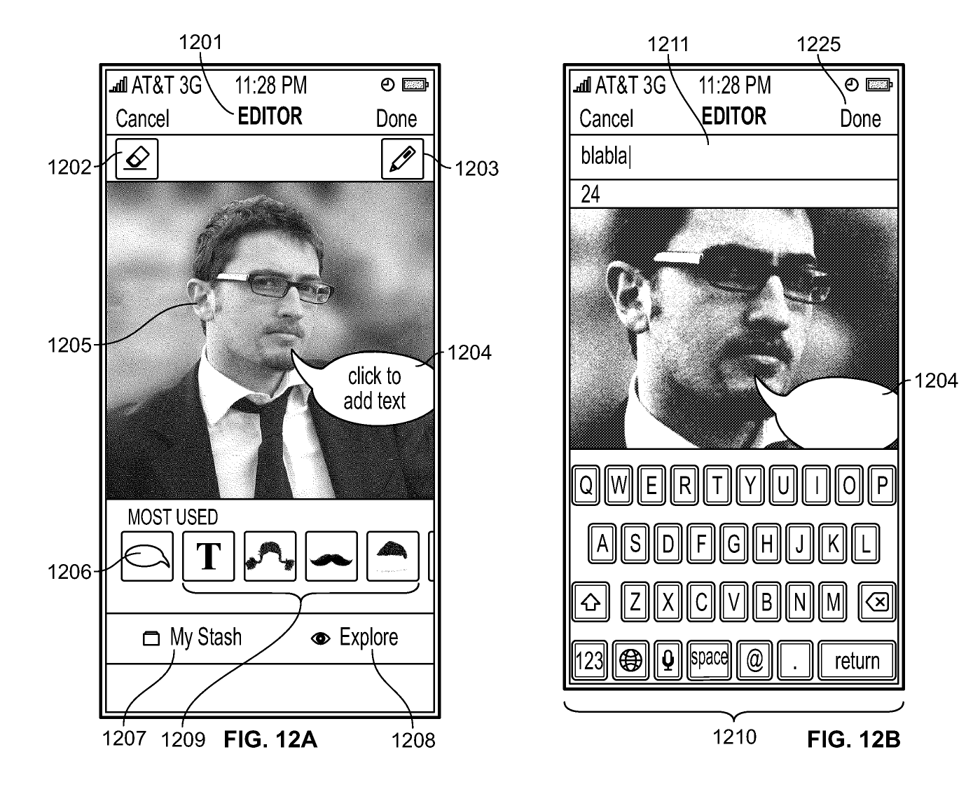

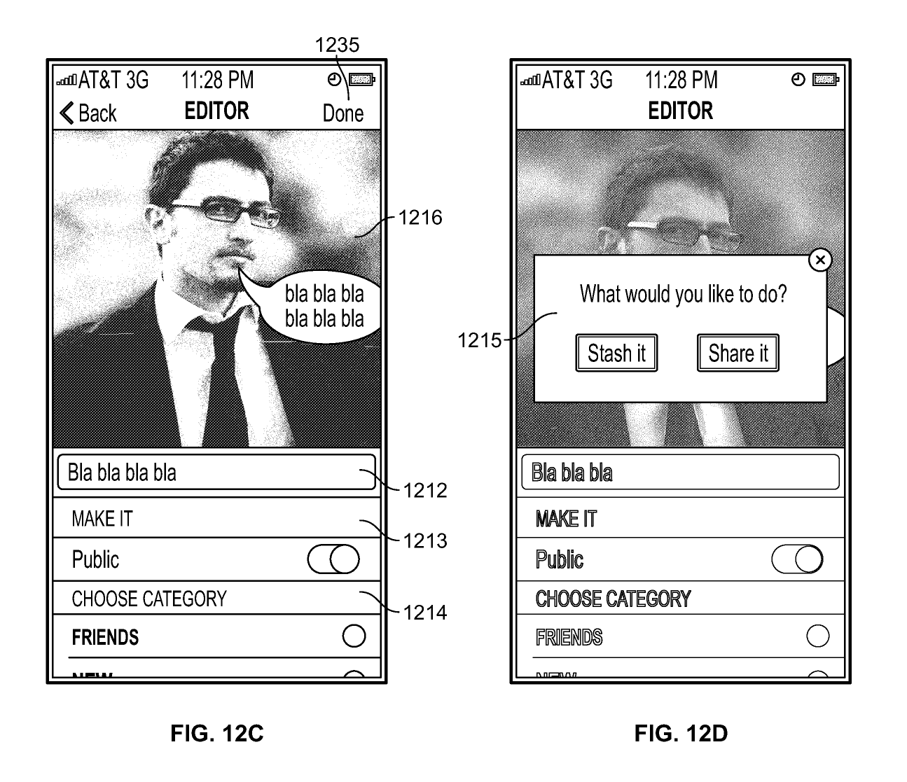

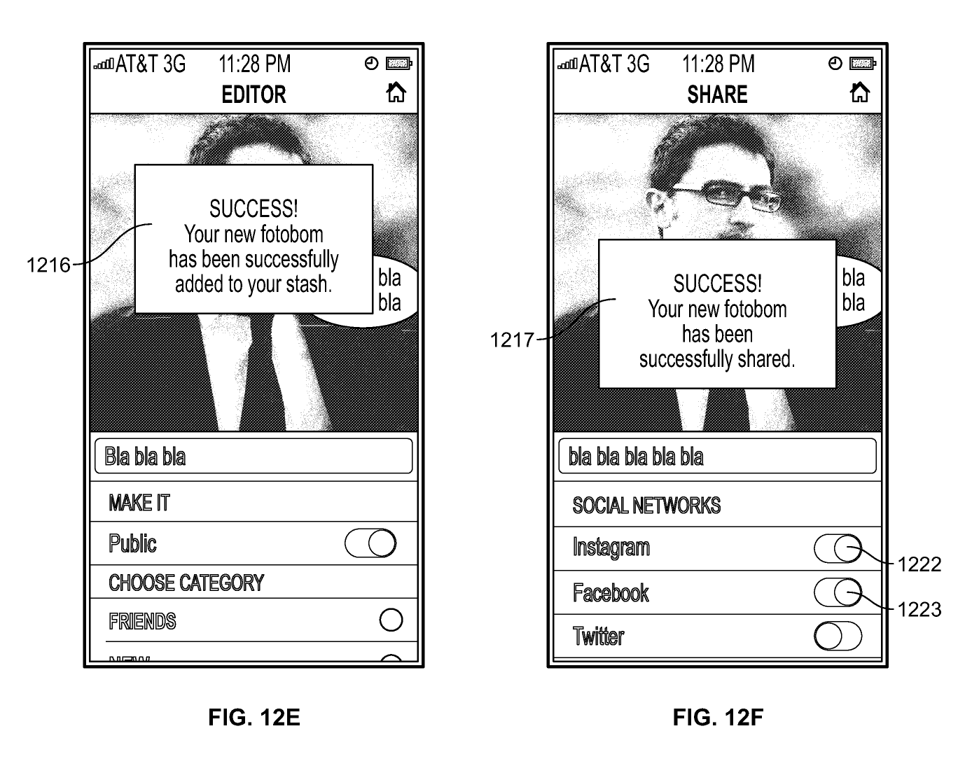

FIG. 12A shows another exemplary interface of the FOTOBOM editor page 1201 as disclosed in an embodiment of the application described in the present specification. In this case, target image 1205 is selected to be “BOM'ed” by the user. When selected, bubble BOM 1206 produces a bubble box 1204 on the interface, in which the user can write a message. Area 1209 is used to display pre-existing BOMS that are frequently used and is provided on the main editor page so that they are easily accessible to the user. In an alternate embodiment, area 1209 is a scrolling menu of frequently used BOMS. Button 1207, when selected, provides access to the “STASH” or user home page as described earlier. Button 1208, when selected, provides access to an “EXPLORE” page which can be used to explore various other categories of images accessible to the application. The user can visit the “STASH” or the “EXPLORE” page using these shortcut buttons to select a different BOM from those locations. Button 1202 activates an eraser tool. Button 1203 is used to activate a text pencil tool. Eraser tool 1202 and pencil tool 1203 can be used to make minor modifications to and/or fine tune the images.

Once a user clicks on bubble box 1204, the user is redirected to a new screen shown in FIG. 12B, which represents another exemplary interface of the FOTOBOM editor page of the application of the present specification, in an embodiment. In FIG. 12B, area 1210 is used to display a keyboard for typing text to be included in the bubble box 1204. Text box 1211 is used to display text that is typed by the user for inclusion in the bubble box 1204. Once the user has finalized the text to be included in bubble box 1204, the user selects the done button 1225 and the application creates a new FOTOBOM image 1216 as shown in FIG. 12C. FIG. 12C represents another exemplary interface of the FOTOBOM editor page, where the user can define the basic properties of new FOTOBOM image 1216. Input area 1212 and icons 1213 and 1214 represent the options to define name, privacy settings and category of the FOTOBOM respectively. In an embodiment, once the basic properties have been defined, the user presses the done button 1235 shown in FIG. 12C and subsequently, the user is redirected to a new screen as shown in FIG. 12D. FIG. 12D, represents another exemplary interface of the FOTOBOM editor page showing options available to the user after a new FOTOBOM is created and its basic properties such as, but not limited to, name, privacy settings and category, etc. have been defined. In FIG. 12D, pop-up window 1215 is used to display options provided to a user to either Stash/Save the new FOTOBOM or Share it. If the user opts to stash the FOTOBOM, the user is presented with another pop-up window 1216 shown in FIG. 12E, which displays a message that the image has been successfully stashed to the user STASH page, if successful. If the user opts to share the FOTOBOM, the user is presented with various options for the user to share the image over social networking platforms as shown in FIG. 12F. Similar to the embodiment depicted in FIG. 11E, in one embodiment, the application page includes buttons 1222 and 1223 to share the FOTOBOM on Instagram® and Facebook® respectively. Once the user selects an option and provides corresponding input to the application, the application displays a message 1217 that the image has been successfully shared. In an embodiment, after any step such as selecting the social network in the above example, to provide an input to the application, the user can press or touch an enter or next screen key on the keyboard, or swipe the display on the user's device to get to the new home screen.

In an embodiment, the application allows a user to tag other users with the specific BOMS or FOTOBOMS created by the user. The application subsequently notifies the tagged users that their profile has been tagged with a specific BOM or a FOTOBOM created by another user. In an embodiment, the BOMS OR FOTOBOMS with which a user has been tagged are stored in the STASH/image gallery of the respective user with his permission. The tagged user can subsequently share these BOMS OR FOTOBOMS with other users in his network.

In an embodiment, the saved FOTOBOMS can be used as personalized emoticons while communicating with other users over various internal or external messaging applications. The emoticons are, in an embodiment, a pictorial representation of a facial expression or other expression which serves to lend tone to a sender's written communication, defining its interpretation. Usually, in all messaging applications such as Facebook®, Gtalk®, Whatsapp®, Wechat®, etc., a library of standard emoticons is embedded in the application, which is accessible to the users. The emoticons are very often used in communication over the messaging applications to emphasize a point. In this embodiment, the user can access, through various internal or external messaging applications, a library of personalized emoticons created with the help of BOMS and FOTOBOMS and use them in his communication with other users.

In another embodiment, the application enables the creation of a new virtual keyboard connected to the operating system running on the user device and comprising a library of personalized emoticons. Access to a virtual keyboard comprising the personalized emoticons allows the users to share emoticons as part of a text line while communicating on the messaging applications instead of accessing a separate image file to access each emoticon. In an embodiment, the user can activate the keyboard through the settings menu in the operating system. In various embodiments, while within the social network of the application of the present specification, or while within another social networking platform, such as Instagram® or Facebook®, the user can access the virtual keyboard to share the customized emoticons with other users. Therefore, in various embodiments, the virtual keyboard provides quick user access to the emoticons created from modified images and/or video frames by the application.

In another embodiment, the application described in the present specification enables the creation of a closed group of users on a direct messaging platform, wherein each member of the group can access the library of personalized emoticons stored in the STASH/image library of other members in the group.

In an embodiment, the application described in the present specification provides the user with the functionality of accessing or enabling a virtual keyboard within the application interface. In some embodiments, upon receiving user instruction, the native or default keyboard provided within the application can be replaced by a virtual keyboard which contains shortcuts and tools for accessing and manipulating images as well as saved BOMS and FOTOBOMS, including created emoticons.

In some embodiments, the virtual keyboard is customized. In an embodiment, the customized virtual keyboard is a separate application which the users have an option to download, either separately or with the FOTOBOM application, on their device. In an embodiment, users can share their customized virtual keyboard with other users in a network. In another embodiment, the virtual keyboard can be shared across other applications. In an embodiment, the virtual keyboard is a separate application which is compatible across various applications, such as Instagram® and Facebook®, on multiple platforms such as iOS, Android, Windows, etc. and can be used across multiple applications in addition to the FOTOBOM application.

In an embodiment, the images, such as BOMS and FOTOBOMS as described in the present specification, are also referred as stickers or emojis. The virtual keyboard contains a gallery of such stickers or emojis which can be accessed by the user.

In an embodiment, the virtual keyboard described in the present specification is dynamic in nature such that the various stickers or emojis linked to a virtual keyboard of a user changes based on settings for the corresponding user. In an embodiment, the images linked to a virtual keyboard changes when new images are posted or uploaded by the other users in the network. In another embodiment, the virtual keyboard is constantly populated with new images corresponding to specific themes, which may be preselected by the user, and which are posted or uploaded in the application.

In an embodiment, the various stickers or emojis are stored in a remoter server and are accessed by the user device through the virtual keyboard. In an alternate embodiment, some of these stickers are available for quick access and are stored in the user device itself for quick access. In an embodiment, the stickers available for quick access to a user through the virtual keyboard comprise various categories such as the stickers previously stored by that specific user in his or her stash or stickers linked to the location of the user, and the like.

In an alternate embodiment, the user can search for stickers or emojis related to any subject and the application provides access to stickers in the entire application network which are related to that subject. In another embodiment the application is integrated with at least one internet search engine so that the user can search the internet for locating or potentially creating new stickers from various image sources on the internet. In another embodiment, the user can buy stickers from a gallery of stickers from the application itself. In another embodiment, the users can buy stickers from other users in the network. In an embodiment, a marketplace interface is provided within the application for purchase and trading of stickers among various users and may charge a fee or commission for the same.

In an embodiment, the user can enable or access the virtual keyboard of this application while running other applications such as messaging applications and social networking applications to access, modify and share stickers provided in this application over these applications.

In an embodiment, the virtual keyboard contains various editing tools to modify the images. In an embodiment, the editing tools include common functions such as, but not limited to, rotate, resize, drag, drop, copy, paste, save images and perform color modification on the images.

In another embodiment, the stickers or emojis available within the application network may be rated by various users on a standardized scale such as on a scale of 1 to 10. The various parameters such as average rating and number of views related to a specific sticker are displayed alongside the sticker to showcase its current popularity on the network. In an embodiment, while searching for stickers on any subject, a user can sort the search results using various filters. In an embodiment, the user can sort the search result based on the user rating for each sticker to view the best rated stickers in any category. In an alternate embodiment, each sticker is stored along with its metadata which comprises parameters such as, but not limited to, sticker category, size, resolution, etc. In an embodiment, the user can filter the search results based on various metadata parameters.

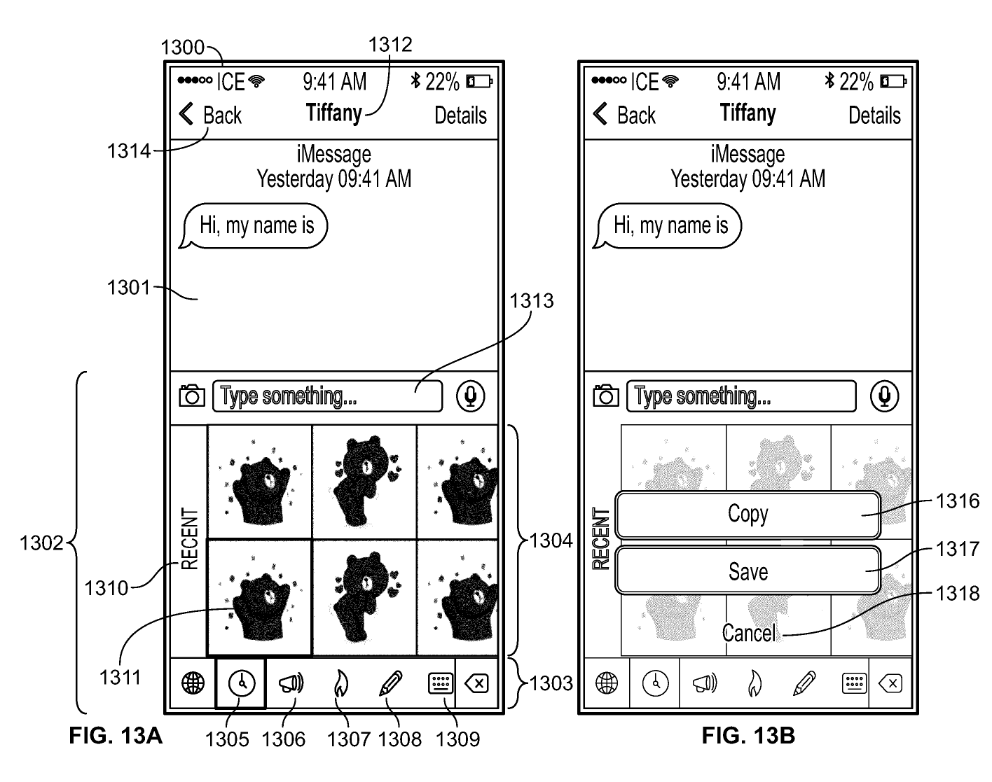

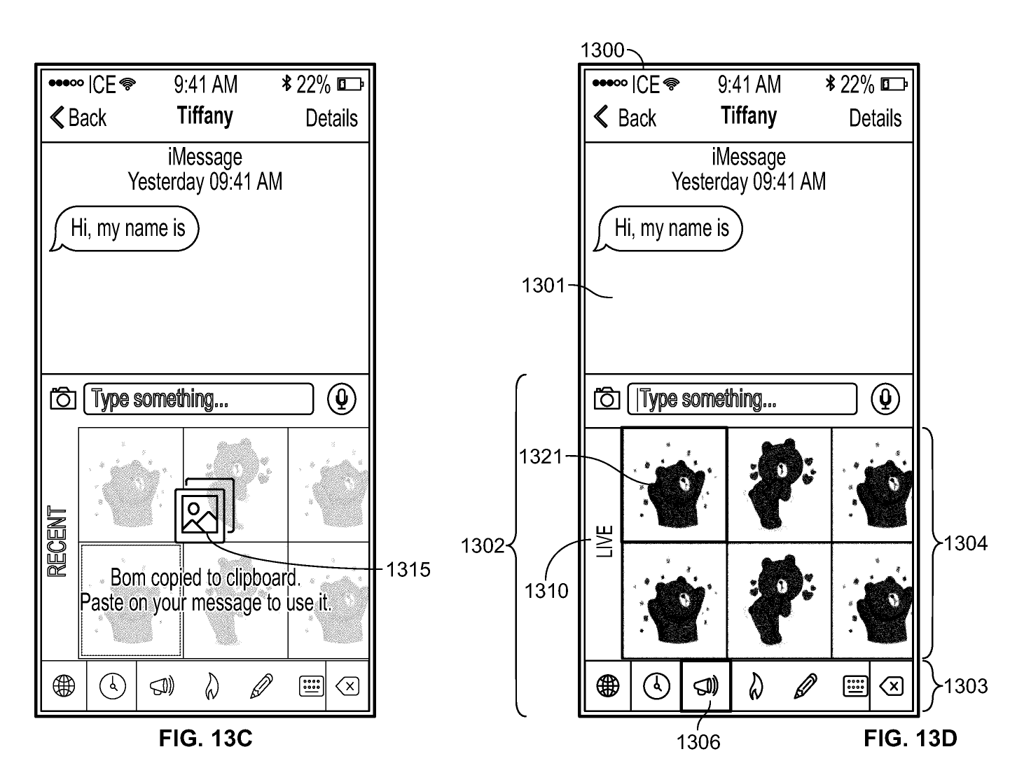

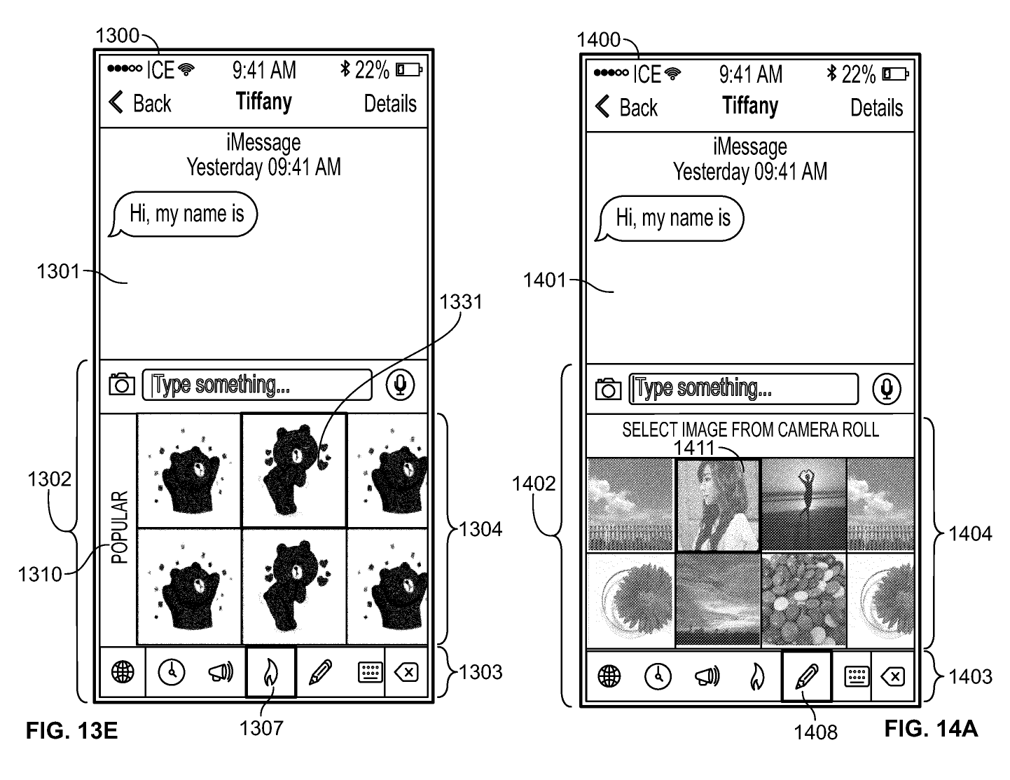

FIG. 13A illustrates an exemplary interface of the virtual keyboard of the application described in an embodiment of the present specification. As shown in FIG. 13A, the application interface 1300 comprises a messaging or dialogue box 1301 through which the user can communicate with other users in the network. In an embodiment, the application interface highlights the name of user 1312, which in this image is shown as ‘Tiffany’ and is displayed on the top portion. As shown in FIG. 13A, the user has enabled the virtual keyboard 1302 which is displayed over the default interface or keyboard in the bottom portion of the application. The virtual keyboard 1302 provides shortcuts and tools for accessing, modifying and sharing various images or stickers available on the network. In an embodiment, the virtual keyboard 1302 comprises a navigation menu 1303, an image display section 1304 and a text input box 1313. The navigation menu 1303 comprises various options or tools for using the virtual keyboard 1302. In an embodiment, the navigation menu 1303 comprises three menu options 1305, 1306 and 1307 to access images or stickers separately classified under ‘RECENT’, ‘LIVE’ and ‘POPULAR’ categories, respectively. In an embodiment, the images which were most recently accessed are classified under the category ‘RECENT’ and images which are perceived to be most popular based on the number of times they have been used or the rating they have received from other users are classified under the category ‘POPULAR’. Images which are most recently uploaded in the system by other users in the local network of user 1312 are classified under the category ‘LIVE’. One of ordinary skill in the art will appreciate that the manner in which the above categories have been described is for illustration purposes only and there can be multiple ways to classify the images under various options or categories in the navigation menu. In an embodiment, the user can customize the names of various categories and the type of images required under each category in the navigation menu.

Upon selection of a category in the navigation menu 1303 the stickers corresponding to that specific category are displayed in the image display section 1304. In the embodiment shown in FIG. 13A, the menu option ‘RECENT’ 1305 is shown highlighted or selected and accordingly the image display section 1304 comprises images which were most recently accessed by the user. In an embodiment, the name of corresponding category ‘RECENT’ is displayed on a vertical bar as shown by icon 1310. The user can select any of the images shown in the image display area 1304 and use it for any further requirement such as to share it over other applications or to create a FOTOBOM. In the above embodiment, the image 1311 is shown highlighted or selected by the user, as indicated by a different colored border around image 1311.

In an embodiment, the user device is a touch screen device and various inputs such as instructions to select a specific category in the navigation menu 1303 or to select a specific image can be provided through a touch or tap on the screen. In an embodiment, the navigation menu 1303 can be scrolled in either direction to see all available menu options.

In an embodiment, the navigation menu 1303 comprises a menu option 1308 which is used to enable or access an image editing tool. In another embodiment, the navigation menu 1303 comprises a menu option 1309 which is used to enable a keyboard such as a QWERTY keyboard used to input any text. In an embodiment, the user can enable the keyboard by tapping on menu option 1309 or alternatively on the text input box 1313.

As shown in FIG. 13A, the user can go back to the previous page in the application by selecting the button ‘back’ 1314.

FIG. 13B illustrates an exemplary interface of the virtual keyboard when an image is selected within the application described in an embodiment of the present specification. In FIG. 13A, when the user opens image 1311, which is already selected by the user (by tapping on the same in a touch screen device), the application interface displays the screen illustrated in FIG. 13B. In an embodiment, the user can select an image by tapping it once such as the image 1311 in FIG. 13A. Tapping the same image twice enables the image to be selected for further processing, in an embodiment. When the image is selected for processing, the screen shown in FIG. 13B is displayed wherein the user is provided with options such as, but not limited to, either copy the image 1316 on a clipboard or save the image 1317. The user is also provided with the option to cancel the selection as depicted by icon 1318. In case the user selects the option 1318 to cancel the selection, the application returns to the screen shown in FIG. 13A. In an embodiment, if the user selects the option to copy the image 1316 the screen shown in FIG. 13C is displayed wherein a confirmation message 1315 that the image has been copied is displayed on the screen. In an embodiment, after an image is copied by the user, the user has the option to paste it in other locations such as in the messaging box 1301 in FIG. 13A and share it with other users.

FIG. 13D illustrates an exemplary interface of the virtual keyboard in the application when the ‘LIVE’ category is selected from the navigation menu in an embodiment of the present specification. As shown in FIG. 13D, when menu option 1306, which in one embodiment, corresponds to the ‘LIVE’ category, is chosen from the navigation menu 1303 in virtual keyboard 1302 of the application interface 1300, the images or stickers corresponding to ‘LIVE’ category are displayed in the image display section 1304. In an embodiment, the ‘LIVE’ category comprises images which have been recently uploaded in the FOTOBOM application network. The user can select any of these images or stickers for further processing. In the above embodiment, image 1321 is shown highlighted as it has been selected by the user.

FIG. 13E illustrates an exemplary interface of the virtual keyboard when the ‘POPULAR’ category is selected from the navigation menu in an embodiment of the present specification. As shown in FIG. 13D, when menu option 1307 which, in one embodiment, corresponds to the ‘POPULAR’ category, is chosen from the navigation menu 1303 in virtual keyboard 1302 of the application interface 1300, the images or stickers corresponding to ‘POPULAR’ category are displayed in the image display section 1304. In an embodiment, the ‘POPULAR’ category comprises images which are perceived to be most popular based on the number of times they have been used or the rating they have received from other users on the network. The user can select any of these images or stickers for further processing. In the above embodiment, image 1331 is shown highlighted as it has been selected by the user.

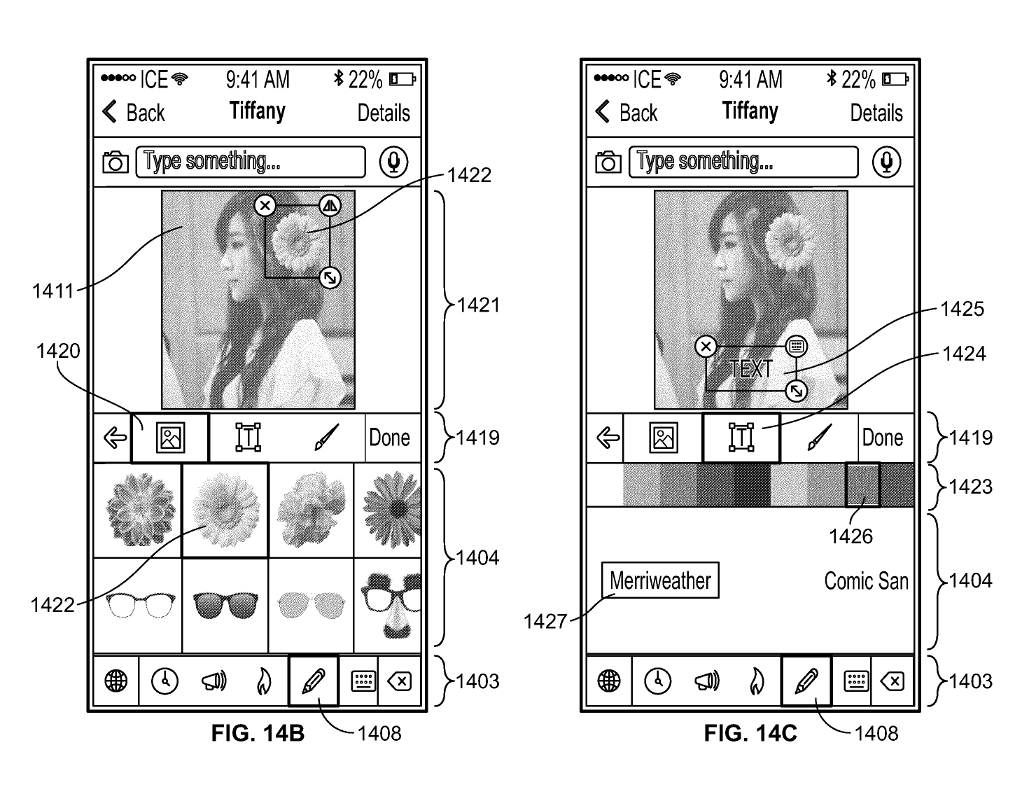

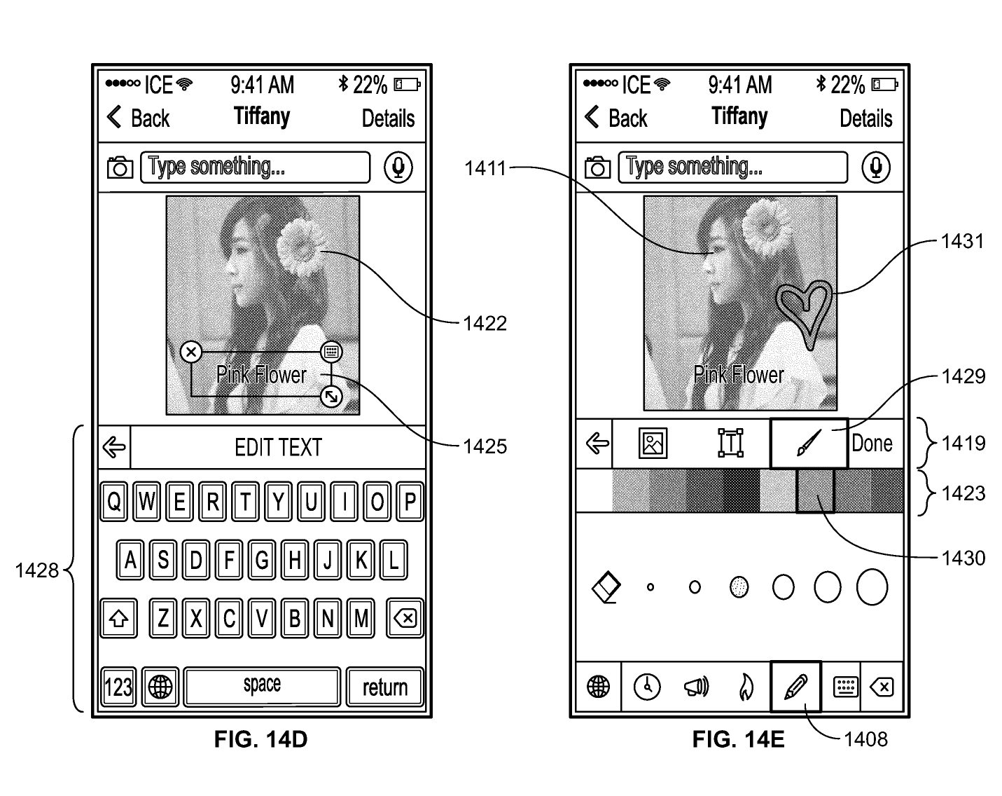

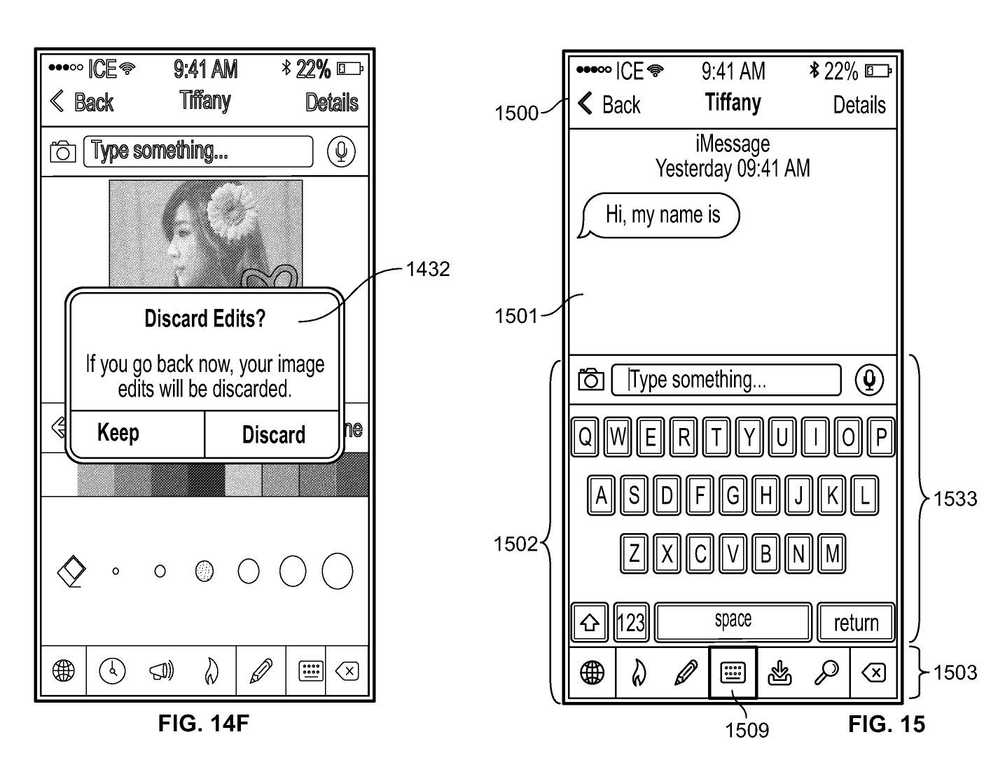

Reference is now made to FIG. 14A, FIG. 14B, FIG. 14C, FIG. 14D, FIG. 14E and FIG. 14F, all of which illustrate various exemplary interfaces of the virtual keyboard feature of the application when an image editing tool is selected from a navigation menu in accordance with an embodiment of the present specification. As shown in FIG. 14A, the FOTOBOM application 1400 comprises a messaging or dialogue box 1401 through which a user can communicate with other users on the network. In an embodiment, the virtual keyboard 1402 is enabled by the user and an image editing tool 1408 is selected from the navigation menu 1403 of the virtual keyboard as shown in FIG. 14A. Upon selection of image editing tool 1408, in an embodiment, the user is directed to a camera roll to select an image for modification. As shown in FIG. 14A, the various images of the camera roll are displayed in the image display section 1404. In an embodiment, the user can scroll through the images shown in the image display area 1404 to see the entire gallery of images by touching and swiping the screen in either direction. The user can subsequently select any image for editing by touching or tapping the image.

In an embodiment, as shown in FIG. 14A, image 1411 in the image display section is shown as having a highlighted border as it has been selected by the user. Once the user taps the image 1411, the application 1400 directs the user to a new screen shown in FIG. 14B, wherein the image 1411 is shown in the main display area 1421. In an embodiment, the selection of editing tool 1408 also provides another navigation menu 1419 which comprises various tools or features which can be used for editing the images. In an embodiment, the navigation menu 1419 comprises various options, such as stickers, text, etc., which may be inserted over the image 1411 in main display area 1421. In the embodiment shown in FIG. 14B, option 1420 is selected in the navigation menu 1419 which corresponds to various stickers or BOMS that may be accessed and used through the image editing tool 1408. Upon selection of option 1420, the various categories of stickers available through the editing tool are displayed in the image display section 1404.

As shown in FIG. 14B, two horizontal rows of stickers are shown, the top one comprising various images of flowers and the bottom one comprising various images of sunglasses. In an embodiment, the user can scroll the display section 1404 in a horizontal direction to see more options of flowers and sunglasses respectively. In another embodiment, the user can scroll the display section 1404 in a vertical direction to see more categories of images apart from flowers and sunglasses. One of ordinary skill in the art would appreciate that the image categories shown here are for illustration purposes only and there could be multiple methods for maintaining and displaying sticker galleries which can be used by accessing the image editing tool 1408. In an embodiment, the user can select any of the stickers or images shown in the display area 1404 to insert it over the image 1411. As shown in FIG. 14B, the sticker 1422 is highlighted or selected and the same sticker is shown superimposed over the image 1411 in the main display area 1421. In an embodiment, the user can drag/drop and resize the sticker 1422 to place it at the desired coordinates over the image 1411. In another embodiment, the user can apply various image filters and can also change the color of sticker 1422 by selecting a new color from a predefined list of available colors in the application 1400.

In another embodiment, as shown in FIG. 14C, the navigation menu 1419 also comprises a text insertion tool 1424 which can be used to insert text over images. As shown in FIG. 14C, upon selection of the image editing tool 1408, navigation menu 1419 is displayed which provides various tools or features to edit the images. Upon selecting text insertion tool 1424 from navigation menu 1419, a text box 1425 is superimposed over the image 1411 in the main display area 1421. In an embodiment, the font of the text to be inserted in text box 1425 can also be further selected from available fonts in the application which are displayed in the display section 1404 in FIG. 14C. The user can scroll the display section 1404 to access more fonts available within the application. As shown in FIG. 14C, once the user selects a font 1427, that font is used for the text to be included in the text box 1425 which is inserted over the image 1411. In another embodiment, the virtual keyboard also provides an option to the user to select the color of text to be inserted over the image through another navigation menu 1423. As shown in FIG. 14C, the user has selected the font color 1426 which is used for the text inserted in the text box 1425. In an embodiment, the user can drag and change the location of the text box 1425 to place it at any position over the image 1411 in the main display area 1421.

One of ordinary skill in the art would appreciate here that the options shown in various navigation menus which are depicted here are for illustration purposes only and the number of navigation menus and the respective options in each navigation menu can be customized in multiple other ways to provide maximum options to the user.

In an embodiment, once the user selects the font and color of the text to be included in the text box 1425, the application 1400 directs the user to a new screen as shown in FIG. 14D wherein an alpha-numeric keyboard 1428 is enabled for the user to insert actual, customized text. As shown in FIG. 14D, the user can draft text to be included in the text box 1425 through the keyboard 1428.

In another embodiment, referring to FIG. 14E, the navigation menu 1419 provided with image editor 1408 comprises an option to insert graphics or hand written notes through a pen editor 1429. The user selects the pen editor 1429 from navigation menu 1419 and the font color 1430 from navigation menu 1423 and can draw any shape or insert any handwritten note over the image 1411, in freestyle. In the embodiment shown in FIG. 14E, the user has drawn a shape 1431 which is shown superimposed over image 1411.

Once the user has performed all edits or changes as shown in FIG. 14E, in an embodiment, the user can choose to save or discard the final sticker, as shown in dialogue box 1432 in FIG. 14F. In an embodiment, if the user opts to save the sticker created, the application presents the user with further options to choose the name and location and sharing properties, etc. for the sticker. The user can subsequently access the previously stored sticker for any requirement in the future. In another embodiment, the user is presented with various options to further process the sticker created through the virtual keyboard as illustrated in FIG. 14A to 14E. The user can select the appropriate option from a dialogue box.

FIG. 15 illustrates an exemplary interface of the application described in the present specification when an alphanumeric keyboard option is selected from the navigation menu within the virtual keyboard in accordance with an embodiment. The navigation menu 1503 of the virtual keyboard 1502, which is located within application 1500, provides an option to enable an alpha-numeric keyboard 1533 such as a QWERTY keyboard to input text. Once the user selects the option 1509 from navigation menu 1503 as shown in FIG. 15, a keyboard 1533 is displayed which can be used by the user to input any text. The keyboard 1533 can be used in a variety of applications such as while typing a message in the messaging box 1501 shown in FIG. 15.

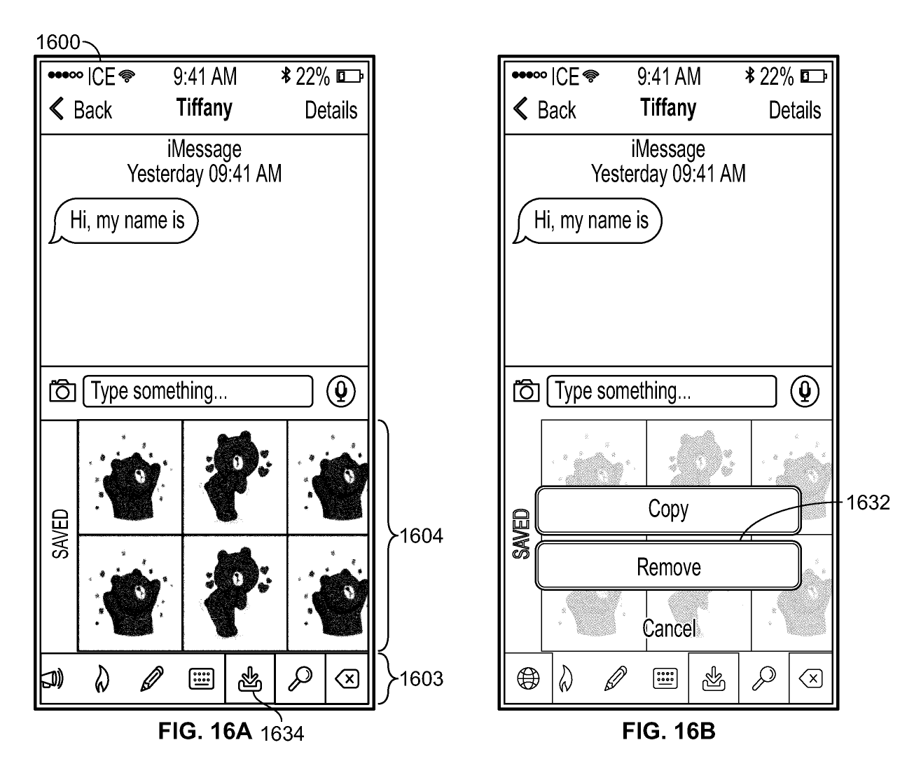

FIG. 16A and FIG. 16B illustrate exemplary interfaces of the application described in the present specification when an option to view the saved stickers is selected from the navigation menu within the virtual keyboard in accordance with an embodiment. In an embodiment, the navigation menu of the virtual keyboard provides an option to view and use the stickers already saved by the user. As shown in FIG. 16A, once the user selects the saved stickers option 1634 from navigation menu 1603 of FOTOBOM application 1600, the stickers which are already saved by the user are displayed in the display section 1604. The user can scroll the images to see the entire collection and select and use any of these images. In an embodiment, once the user selects any of these images or stickers, a message box is displayed such as the message box 1632 in FIG. 16B which provides options to the user to either copy the corresponding sticker or remove it from the collection or cancel the action.

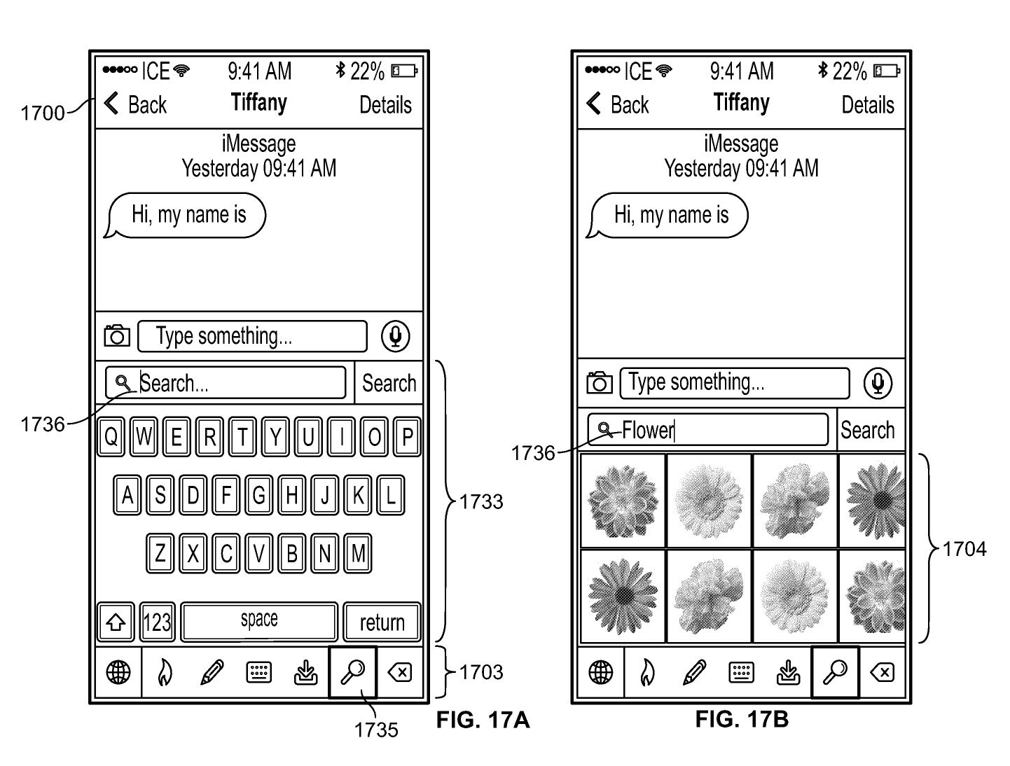

FIG. 17A and FIG. 17B illustrate exemplary interfaces of the application described in the present specification when an option to search stickers is selected from the navigation menu in the virtual keyboard in accordance with an embodiment. In an embodiment, the navigation menu of the virtual keyboard provides an option to search stickers available through the FOTOBOM network. As shown in FIG. 17A, once the user selects the search option 1735 from navigation menu 1703 of application 1700, a virtual text keyboard 1733 is displayed along with an input box 1736 through which the user can insert a keyword and search stickers corresponding to that keyword. Once the user inputs a keyword in input box 1736, the stickers corresponding to that keyword are displayed in the display section 1704 as shown in FIG. 17B. Subsequently the user can select any of these stickers and can use it to perform any other functions such as to create FOTOBOMS or new stickers or to post it over a shared network or external application, etc.

In an embodiment, BOMS and FOTOBOMS can be created using the virtual custom keyboard by directly accessing the BOM editor tool explained in earlier embodiments. Using the virtual keyboard provides a more convenient method to create new BOMS or stickers as it provides quick access to several system features through shortcuts as described in some of the above embodiments.

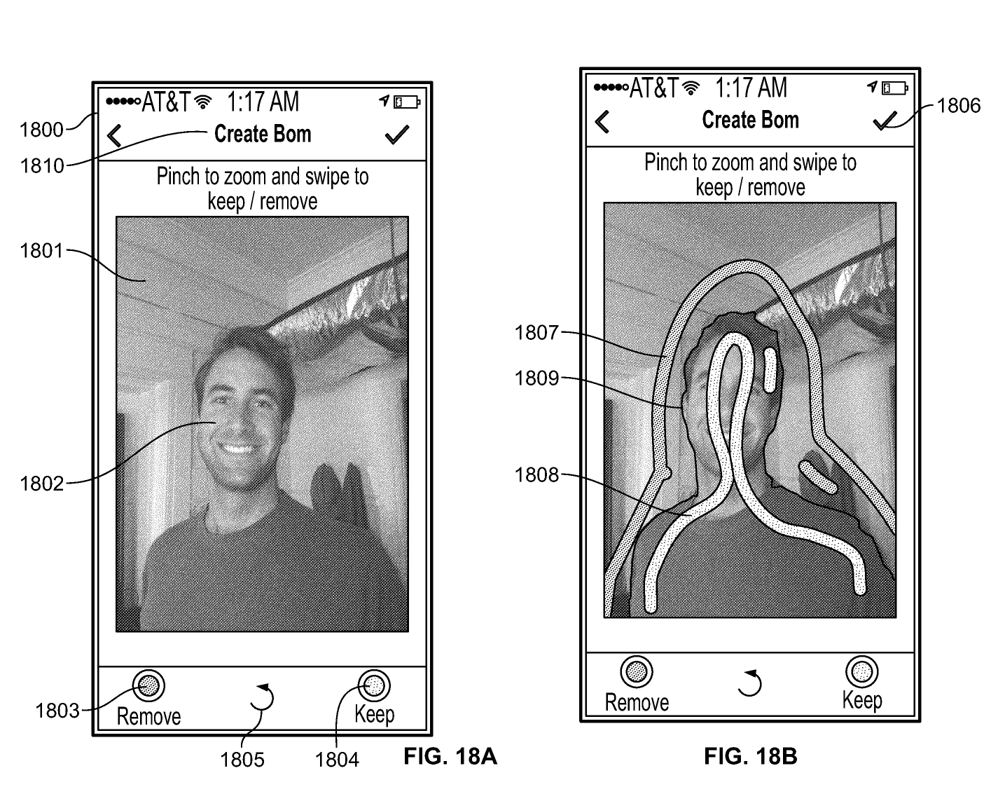

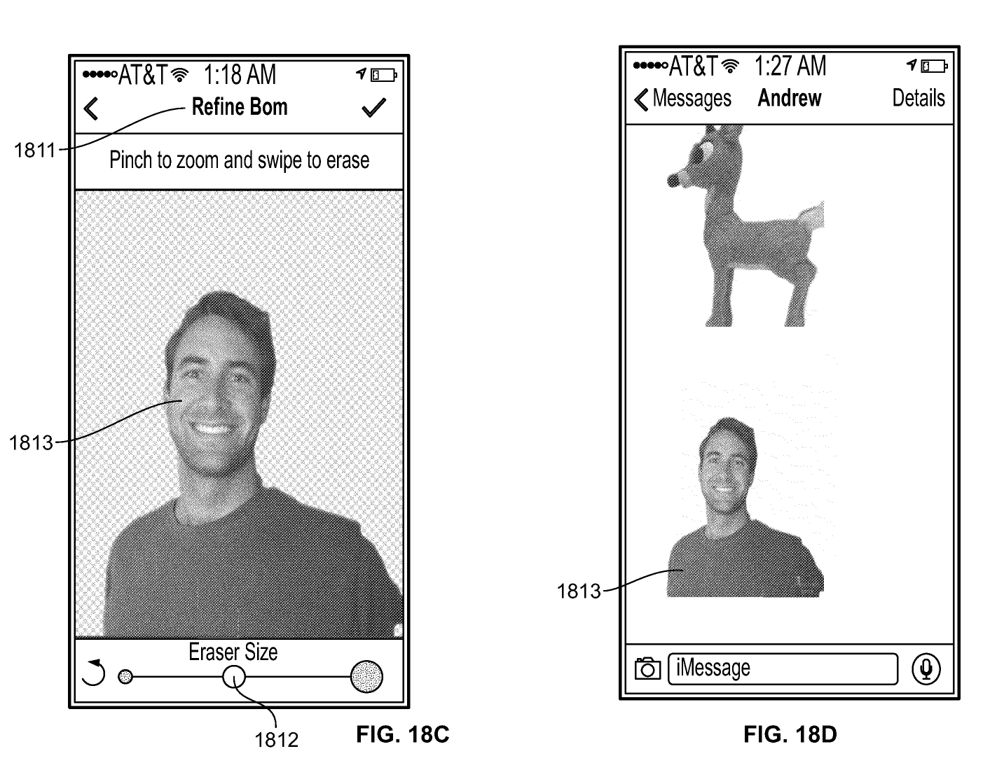

FIG. 18A, FIG. 18B, FIG. 18C and FIG. 18D illustrate exemplary interfaces of the application when an option to create and/or modify BOM images is selected from the virtual keyboard in accordance with an embodiment of the present specification. As shown in FIG. 18A, the application 1800 comprises a BOM creation tool 1810 which has been enabled through the virtual keyboard described earlier. In FIG. 18A, an image 1801 is shown which contains another image 1802 of a person. In an embodiment, to create a BOM, various tools or buttons to remove or keep various sub-portions of image 1801 are provided such as button 1803 to indicate the portions to be removed and button 1805 to indicate the portions to be kept or included in the final BOM image. A button 1805 is provided to reverse or undo any action.

In an embodiment shown in FIG. 18A and FIG. 18B, if the user wants to retain the image of person 1802 redacted from the full image 1801 as the final BOM, the user can select the remove button 1803 and then touch the areas in image 1801 to highlight the portions to be removed. In an embodiment, the user can touch and swipe his or her finger to draw a line over some portions to be removed. Similarly, the user can select the keep button 1805 and then touch and swipe his or her finger to draw a line over the areas in image 1802 to be kept. In an embodiment, the user can draw a line or a shape such as 1807 and 1808 to indicate the portions to be removed and included respectively in the final BOM image. In an embodiment, based on the user input as described above, the system uses advanced image processing techniques such as pixel by pixel comparisons and edge detection process to estimate all the portions which are to be removed or included. In an embodiment, the application estimates a broad outline of the portion to be kept in the final BOM image shown as 1809 in FIG. 18B.

Once the user has indicated the portions to be removed or included in the final BOM image, he can indicate the same to the application though a button 1806 shown in FIG. 18B and the application directs the user to a new screen shown in FIG. 18C which contains the BOM image 1813. In an embodiment, the new BOM image 1813 is opened in an editor such as BOM refine tool 1811 which comprises various tools to further refine the BOM image. In an embodiment, the user can change the size of BOM image 1813 using a sizing tool 1812 shown in FIG. 18C.

In an embodiment, the BOM image can be subsequently used through the virtual keyboard. FIG. 18D illustrates the BOM image 1813 created in FIG. 18C being shared over a messaging application.

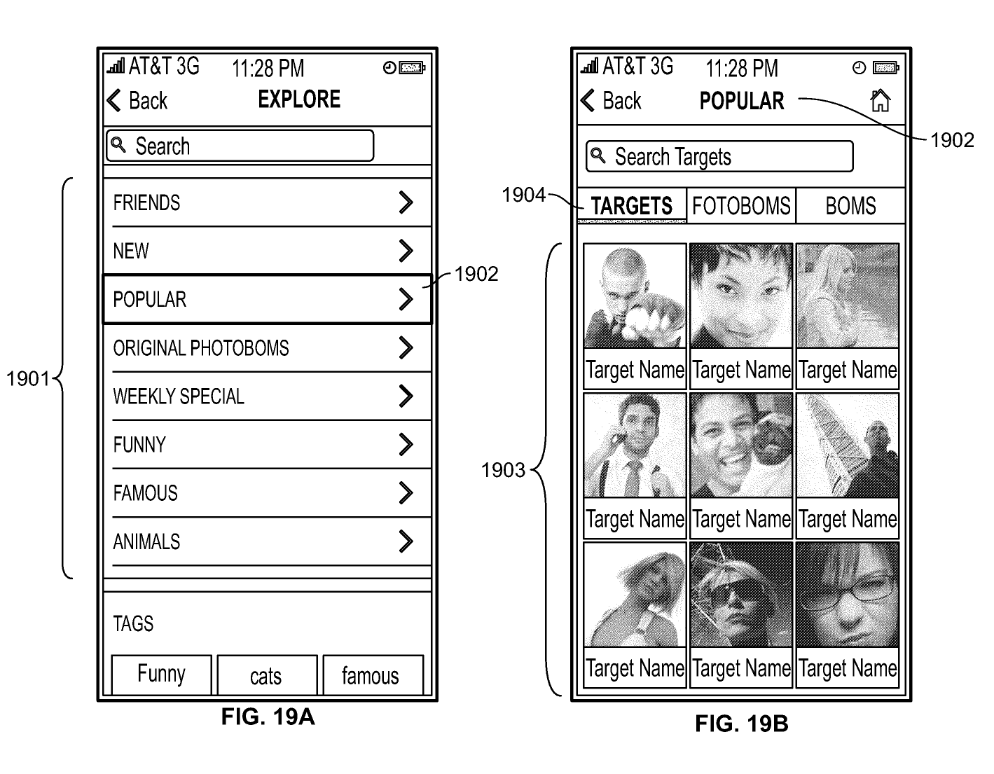

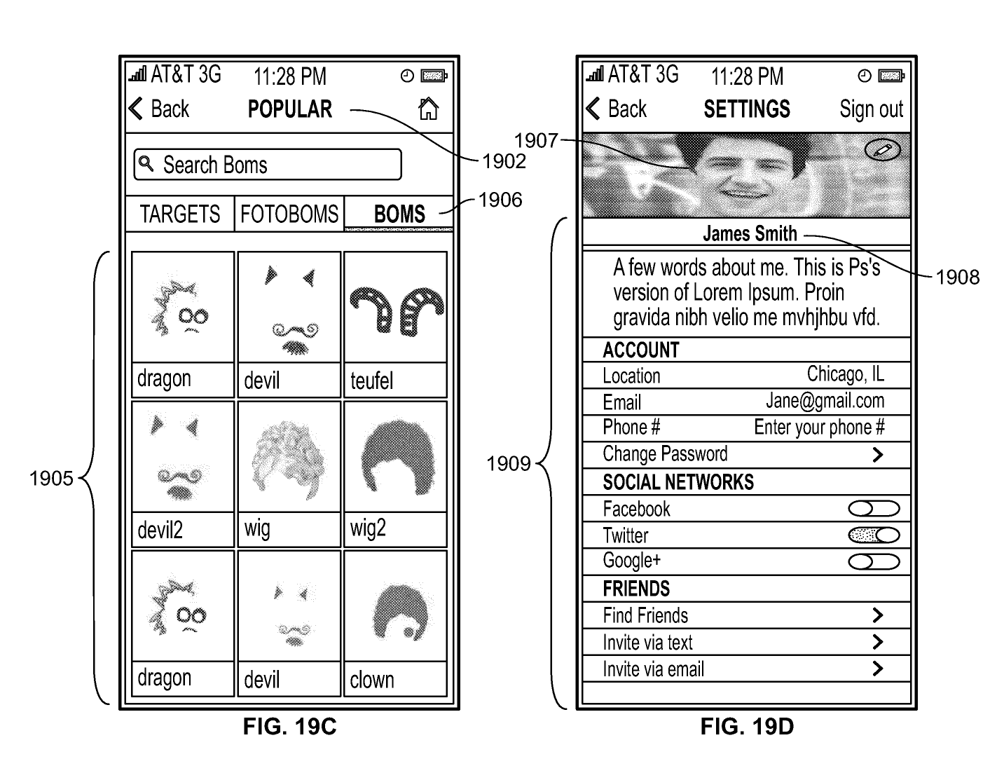

FIG. 19A represents an exemplary interface of an EXPLORE page of the application of the present specification, in an embodiment. When a user selects “EXPLORE” button (shown as 804 in FIG. 8), the user is redirected to a screen shown in FIG. 19A which contains a list of all the categories of images which could be explored further. In an embodiment, the application provides a set of a plurality of categories such as, but not limited to, FRIENDS, NEW, POPULAR, ORIGINAL PHOTOBOMS, WEEKLY SPECIAL, FUNNY, FAMOUS, and ANIMALS, as shown in area 1901 in FIG. 19A. One of ordinary skill in the art would appreciate that the eight categories listed above are exemplary only and not meant to be construed as limiting.

FIG. 19B represents another exemplary interface of the application of the present specification, in an embodiment, showing a specific category selected by the user to explore it further. In FIG. 19A, when a user selects the category 1902, which corresponds to the gallery of ‘POPULAR’ images, the user is redirected to a screen as shown in FIG. 19B which shows the images of BOMS, TARGETS or FOTOBOMS corresponding to the ‘POPULAR’ category 1902. In FIG. 19B, as button 1904 that represents the list of TARGETS is selected, a collection of all TARGET images in the POPULAR category are displayed in the area 1903, which could be ‘BOM’ed to create FOTOBOMS.

Similarly, FIG. 19C represents another exemplary interface of the application, showing the ‘POPULAR’ category 1902, where button 1906, which represents the list of BOMS, is selected and accordingly a collection of all BOM images under the POPULAR category are displayed in the area 1905, which could be used to create FOTOBOMS. Once the user selects any of these BOMs, he is directed to a screen similar to one shown in FIG. 11A to choose the TARGET image to be BOM'ed with the chosen BOM to create a new FOTOBOM.

In an embodiment, in addition to the static image categories, the application enables the user to explore images corresponding to his current location. In an embodiment, when the user tries to explore images corresponding to his location, the application detects the location of the user through a GPS tracking mechanism present on the user device. Subsequently, the application displays images corresponding to the detected location. For example, if a user is at Disneyland®, the application enables the user to explore BOMS and FOTOBOM images corresponding to various Disneyland® characters. This may include the images stored in the application library or those created and shared by other users.

FIG. 19D depicts an exemplary interface showing the account settings page of the application of the present specification, in an embodiment. When a user selects the settings button 805 in the main menu page shown in FIG. 8, the application redirects the user to the settings page as shown in FIG. 19D. An exemplary settings page contains information about the user and includes tools to change account settings. In FIG. 19D, area 1907 is used to display a user's profile image and area 1908 is used to display the user's name. All other important user information such as, but not limited to, e-mail, location, phone number, password settings, social network settings, information related to friends etc. is displayed in area 1909. In an embodiment, the application described in the present specification is compatible with other applications developed on any type of computer platform or operating system such as Android®, Windows®, Symbian®, or iOS®, etc., and allows information exchange with these applications. In an embodiment, APIs (application program interfaces) are provided which may be accessed from other applications to access information stored in the application described in the present specification. In an embodiment, the users can access and modify their account and corresponding information in their STASH through other applications.

In another embodiment, the application described in the present specification is configured such that the information contained in a user's account may be shared with a dynamic program such as a computer or a mobile gaming application.

In an embodiment, the application described in the present specification provides the functionality to modify or process video files in multiple ways. In an embodiment, the application allows recognition of specific sections of an image in a plurality of frames in a video file based on the user feedback and allows performing modifications/operations on these specific sections of images in all the video image frames based on the feedback received only for said plurality of image frames. In an embodiment, the application provides a very convenient feature wherein a video file is separated into multiple image frames and modifications done by the user in a single image frame are automatically applied to all image frames in which similar modifications would be applicable. In an embodiment, when a video file is selected, a first frame of a video is opened in the application described in the present specification and the user is required to input all changes required in the first frame. Once the user completes the changes in the first frame, the system automatically applies similar changes to all other relevant frames in the video file in which such changes are possible. In case the user wants to keep certain sections in an image and remove certain other sections, the user is required to highlight the sections he would want to keep or the sections he wants to remove only in the first frame. The application records the input provided by the user and, one by one, analyzes all frames to identify relevant frames containing sections similar to the sections highlighted by the user and accordingly modifies all relevant frames as per the user feedback received for first frame.

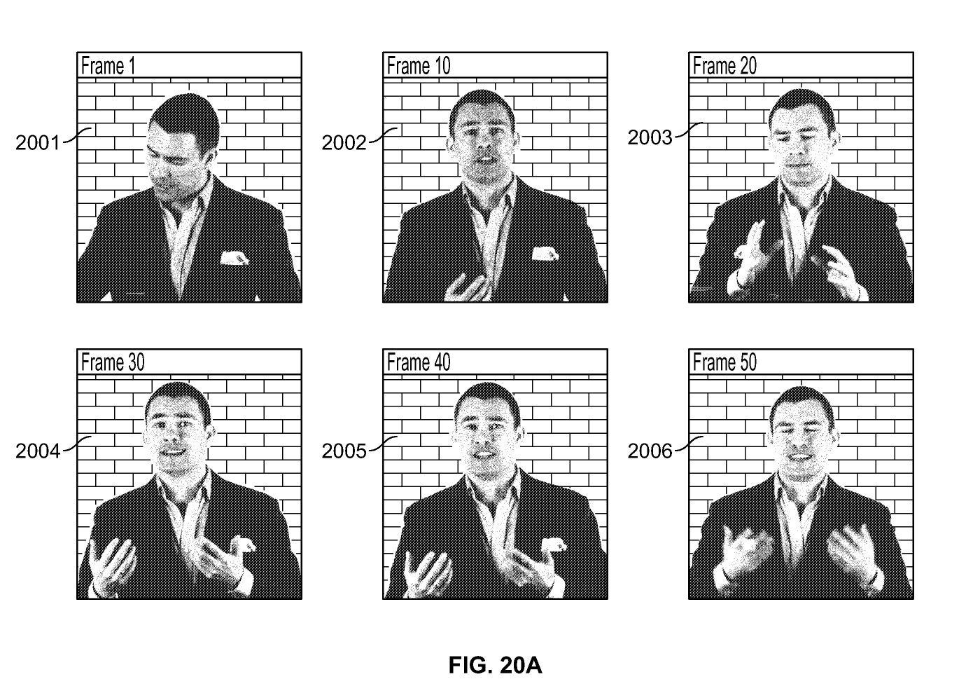

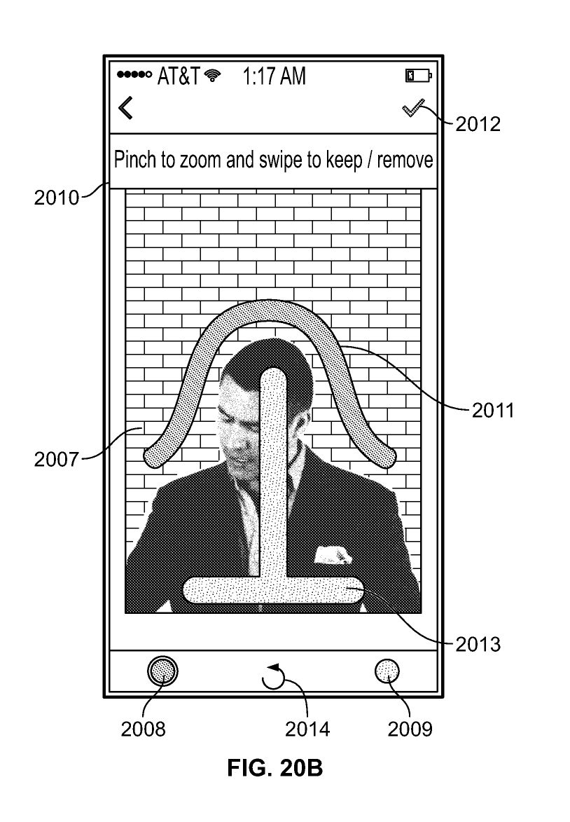

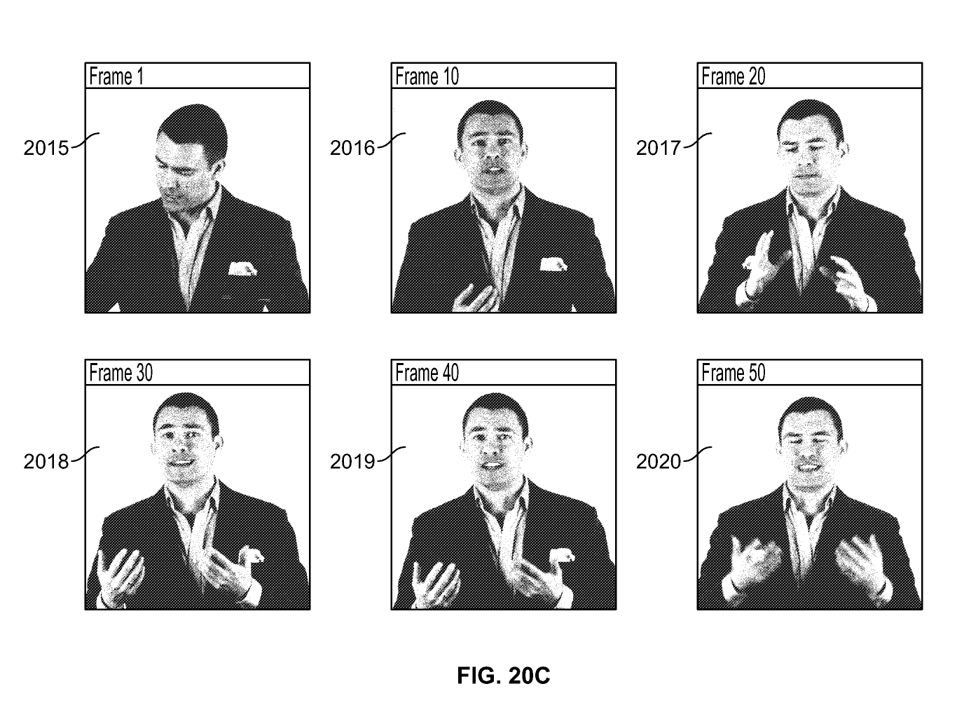

The above embodiment is described with reference to FIG. 20A, FIG. 20B and FIG. 20C. FIG. 20A illustrates a few initial frames from a TARGET video file prior to modification using the application described in the present specification. As shown in FIG. 20A, for reference, six different frames captured from a TARGET video file are illustrated, wherein 2001 represents Frame 1, 2002 represents Frame 10, 2003 represents Frame 20, 2004 represents Frame 30, 2005 represents Frame 40, and 2006 represents Frame 50.

Once the user selects the TARGET video file shown in FIG. 20A for processing, the application is redirected to the screen shown in FIG. 20B, which illustrates an exemplary interface 2010 of a video frame editor page of the application of the present specification, in an embodiment. FIG. 20B shows the video frame editor with selected image 2007 which corresponds to the Frame 1, represented as 2001 in FIG. 20A. In the above embodiment, a first frame from the video file is displayed in the application screen as shown in FIG. 20B. In another embodiment, the user is provided with the option to browse through various frames of the video file and select the exact frame on which he or she would provide the feedback.

In an embodiment, the buttons 2008 and 2009, corresponding to “REMOVE” and “KEEP”, respectively, are used to modify the image 2007 to create a new video image frame. In an embodiment, selection of buttons 2008 and 2009 launches a highlight tool that allows a user to highlight portions of an image. To highlight those sections which are of interest, the user first selects or presses keep button 2009. Subsequently the user highlights the portions which are of interest and the application fills these portions with a first color. To highlight the sections which are not of interest, the user selects or presses remove button 2008. Subsequently, the user highlights the portions which are not of interest and the system fills these portions with a second color. In an embodiment, the first color 2013 is green which depicts the portions of image to be included in the video file and the second color 2011 is red which depicts the portions of image to be excluded from the video file. If at any time the user wants to undo the previous command, the same can be done by pressing the button 2014 which undoes the last command. After providing all information, the user selects “Done” button 2012, which signals the application that scanning is complete. The application subsequently generates a new image by keeping those sections identified by the first color and removing those sections identified by the second color, depicting the new image frame created by the user. In the above embodiment, the user has highlighted the person's image in the first color to retain his image in the video file and has highlighted the background behind the person in the second color to remove this background from the video file. It should be understood by those of ordinary skill in the art that the use of colors to differentiate areas is by way of example only and that any demarcation may be used to differentiate these areas.

The above embodiment describes one specific method through which a user can highlight areas of image the user wants to keep or remove in a video frame. However, one can appreciate that there could be multiple ways in which the system can take instructions from the user. In an embodiment, the user can touch or swipe or click on a portion of the section which is to be included in the image and the system conducts a pixel by pixel comparison of this portion with other areas in the image to detect the entire section corresponding to this portion.

In an embodiment, the application described in the present specification is configured to receive additional instructions from the user for more accurate detection of images. In an embodiment, the video frame editor tool screen in FIG. 20B comprises additional functions or buttons, such as “BORDER”, “SMOOTHEN”, and “GLOW”. When the user selects the button “BORDER”, any subsequent portion highlighted by the user is filled with a brown color to highlight the borders or edges in an image. When the user has selected the buttons “SMOOTHEN” or “GLOW”, any subsequent portion highlighted by the user is colored in yellow color or orange color respectively to highlight the portions of image which requires smoothening or which are to be shown with higher level of glow or brightness. Once the user has provided all information, the application uses the above information for more accurate detection of images. One of ordinary skill in the art can appreciate that while specific colors have been used in this embodiment corresponding to various functions, in an embodiment, other color combinations could be used without departing from the spirit and scope of the present specification. Also, one can appreciate that in embodiments of the present specification, other additional buttons or functions can be provided to identify specific types of portions in an image.

In an embodiment, the application subsequently scans all other video frames of the video file depicted in FIG. 20A to identify frames which contain the sections or objects similar to those highlighted in the first frame as shown in FIG. 20B. The application subsequently modifies all relevant frames based on the feedback received for the first frame by removing the sections which are not required and retaining the sections which are required. Subsequently, the application recreates a new video file with the modified image frames.

In the above embodiment, the new video file in which the background behind the person's image has been removed is illustrated in FIG. 20C with the help of a plurality of frames wherein 2015 represents Frame 1, 2016 represents Frame 10, 2017 represents Frame 20, 2018 represents Frame 30, 2019 represents Frame 40 and 2020 represents Frame 50 of the new video file.

In another embodiment, the user is provided with the option to provide inputs for more than one image frame for scenarios wherein the video file is of relatively long duration and the user wants to modify multiple image sections which are not displayed together in any single image frame in the video. In such a case, the user can browse through various image frames in a video file and then select two or more image frames. Subsequently, the user is required to provide inputs for the selected image frames. In an embodiment, the application analyzes all the image frames in the video file and implements the suggestions provided by the user for the selected image frames on other image frames containing the relevant sections on which user has provided the feedback.

In some embodiments, the video file is processed at a client or user device. In another embodiment, the video file is processed at a remote server such that the video is initially uploaded to a remote server location and subsequently, after the video is processed to generate a new video file as depicted in FIG. 20C, the same is downloaded on the user device. In another embodiment, the video file is processed simultaneously at the client or user device and the remote server location to provide a better user experience in terms of the processing speed.

In some embodiments, the modified first frame, or reference frame, is stored in a virtual keyboard similar to the virtual keyboard described with reference to FIGS. 13A through 13E.

In an embodiment, based on the available bandwidth, memory, and the processing power of the system running the FOTOBOM application, the size of video file that can be processed by the application is restricted. In an embodiment, the application only processes video files of length between 3-10 seconds.

In another embodiment, another tool is used to first crop the selected video file size to make it compatible with the FOTOBOM application requirement. In some embodiments, various parameters such as length, resolution, frame per seconds and other relevant parameters of the selected video are modified using this tool to preprocess the selected video file and make it compatible with the FOTOBOM application requirements.

In some embodiments, the tool used for preprocessing the video file is integrated with the FOTOBOM application.

In an embodiment, wherein the selected video file is of a different format, the video file is first converted into a format supported by the FOTOBOM application. In an embodiment, the FOTOBOM application supports only a single video format, such as an animated .GIF format, and all selected video files are first converted to the supported format before processing them using the FOTOBOM application.

While the application described in the present specification can work with images of any resolution, in an embodiment, the resolution of images is normalized before combining them to create high quality pictures. There could be cases wherein a large mismatch between resolution and size of TARGET images and BOM images might create a problem. For example, if the TARGET image is very large and the BOM image is very small, the resolution of FOTOBOM image created by combining TARGET with BOM might not be perfect. In an embodiment, a standard resolution range is defined and the system requires the TARGET and BOM images to be normalized to fall within this range before combing them.

The normalization of pictures to make them compatible with the system standard has to be done in a very fast and efficient manner to avoid any lag in the user experience. In an embodiment, the system performs the normalization process at a remote server location based on instruction received from the client application running on the user/client device. In an embodiment, as the user selects an image for creating a BOM or a FOTOBOM, the client application described in the present specification sends the image or a web link corresponding to that image to the server for pre-processing. The server retrieves the image and pre-processes it, which includes the steps of normalizing the size/resolution of image and changing the file types and file names to standardized formats. In an embodiment, a copy of the normalized image is stored in the server so that it can be accessed easily for further processing, including the creation of BOMS and FOTOBOMS. Once the pre-processing is complete at the server side, the image is sent to the client device which displays it on the user screen to receive further instruction. In case the user is creating a new BOM, user instructions would comprise information related to sections of the image to be included in the BOM and/or sections of the image to be excluded from the BOM. In case the user is creating a new FOTOBOM, user instructions would comprise information related to the existing BOM to be used, its location, placement details on the TARGET image, etc. On receiving user instructions, client device sends these instructions to the server, which accordingly processes the image based on the user feedback and sends the final completed image to the client device.

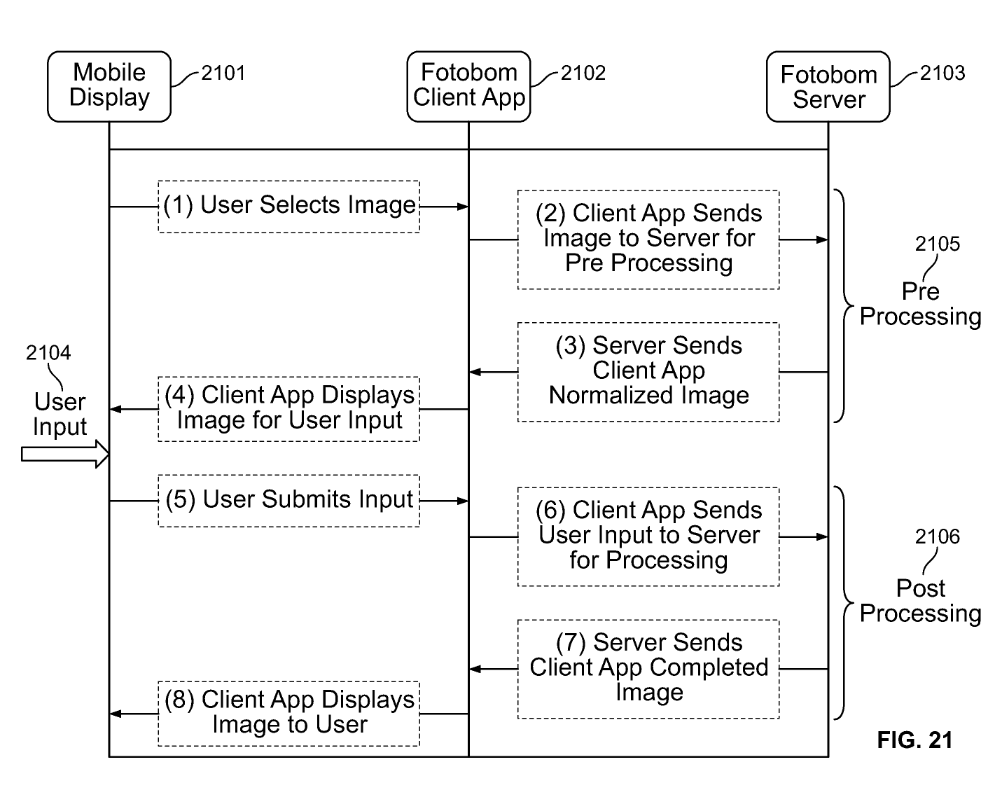

FIG. 21 depicts a flow diagram of the communication between a user, client device and server as per the above embodiment. As shown, 2101, 2102 and 2103 represent the mobile/client device display, FOTOBOM Client application and FOTOBOM server respectively. One of ordinary skill in the art would appreciate that while in this embodiment a mobile device is shown as the client device, any other device which can run the client application described in present specification can be used as a client device. The user input provided through the mobile display is shown as 2104. Steps 2105 and 2106 represents the pre-processing and post processing steps taking place at the server side. In an embodiment, the pre-processing steps represent the steps performed before receiving user input and the post-processing steps represent the steps performed after receiving user input 2104. One major benefit of conducting the normalization of images at a remote server is that the load on the client device is minimal, which means lower client side system requirements and fast speed. Also, in case of any change in the normalization standards, the client side application is not required to be updated. However, the above embodiment is more suitable when internet connectivity speed is good as there could be issues of delay in data transfer when the internet connectivity is slow. As the image selected by the user is first normalized at a remove server location and then displayed on the screen of client device, in case the connectivity speed is slow, it might lead to a bad user experience. To resolve this issue, in an alternate embodiment, the normalization process takes place in parallel while the image is displayed on screen to receive user instructions. In this embodiment, as the user selects an image for creating a BOM or a FOTOBOM, the client application described in the present specification displays the image in a compatible format and size on the user display screen to receive user instructions. Simultaneously, the client application also sends the image or a web link corresponding to that image to server for other pre-processing steps at the server end. In some embodiments, the normalization process at the server side includes, but is not limited to, assigning the image ratio aspect scaling, applying a color palette, modifying a file format and/or applying a compression algorithm. The type of normalization which takes place at the server end includes image resolution adjustment, image ratio adjustment, file type for storage, etc. In an embodiment, a copy of the normalized image is stored in the server so that it can be accessed easily for further processing including creation of BOMS and FOTOBOMS. While the server is pre-processing the image, the client device also receives instructions from the user and sends the same to the server for processing. In case the user is creating a new BOM, user instructions would comprise information related to sections of the image to be included in the BOM and/or sections of the image to be excluded from the BOM. In case the user is creating a new FOTOBOM, user instructions would comprise metadata information related to the existing BOM to be used, its location, placement details on the TARGET image, etc. On receiving the user instructions, the server processes the image further as per user instructions and sends the completed image to the client device for displaying on screen. The above embodiment works much faster in case the client data connectivity speed is slow. However, in case of any change in the normalization standards, the client side application will need to be updated in this model.

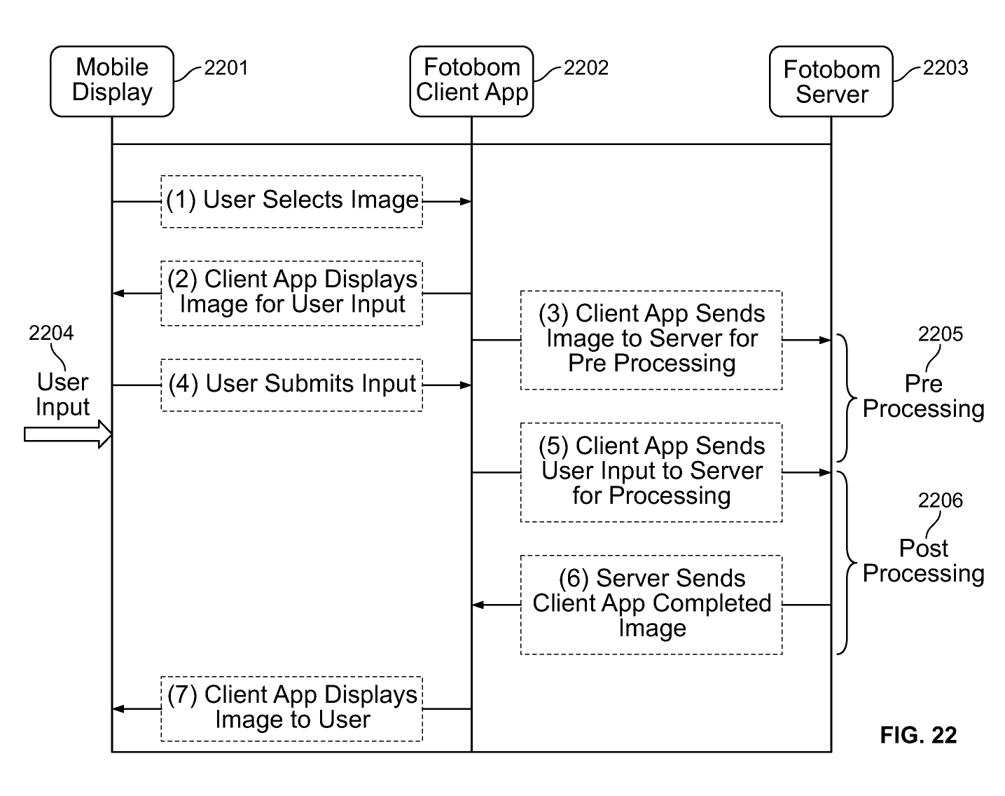

FIG. 22 depicts a flow diagram of the communication between a user, client device and server as per the above embodiment. As shown, 2201, 2202 and 2203 represent the mobile/client device display, FOTOBOM Client application and FOTOBOM server respectively. One of ordinary skill in the art would appreciate that while in this embodiment a mobile device is shown as the client device, any other device which can run the client application described in this specification can be used as a client device. The user input provided through the mobile display is shown as 2204. Steps 2205 and 2206 represent the pre-processing and post processing steps taking place at the server side.

In another embodiment, both the client device and the server are provided with the information about the normalization algorithm and if the client device is capable in terms of its processing capacity, it normalizes the images itself. This is beneficial to speed up client device response and sometimes bypassing the need to send the image to the server. In another embodiment, both the server and client device perform the normalization in order to speed up response times, storage times, etc. The final images normalized at the two locations sync with each other as both the applications use the same normalization algorithm.

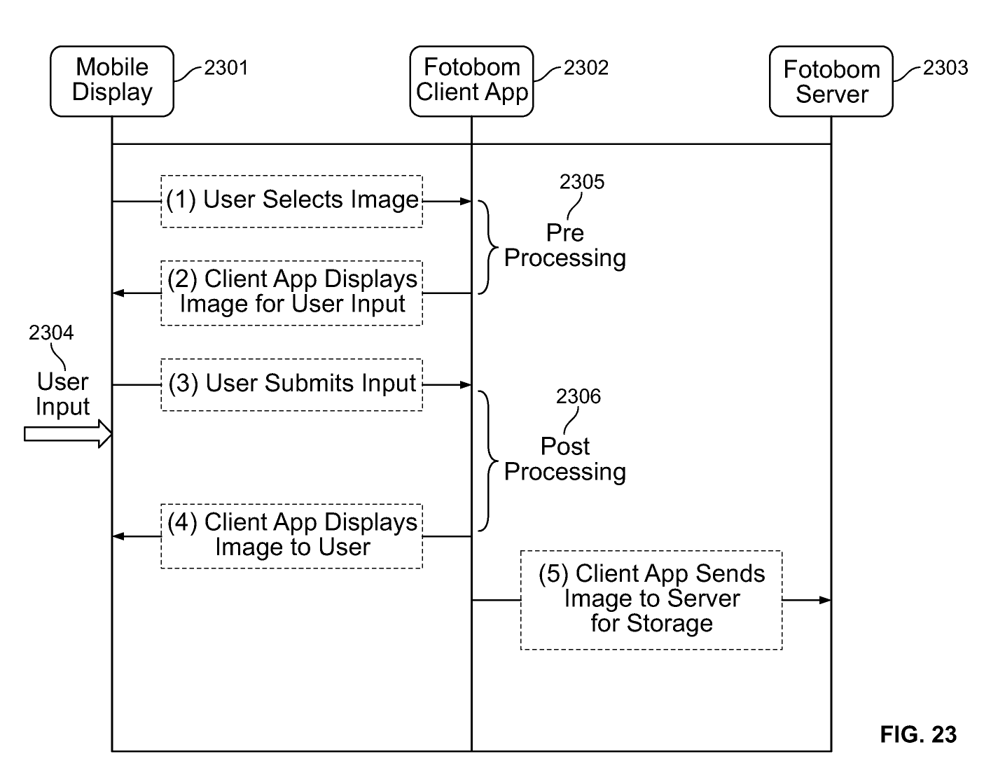

In an embodiment of the present specification, the entire normalization and processing of the image is conducted by the client application. In this embodiment, the processing power of the client application is configured such that the client application is independently capable of processing the image without compromising the user experience. In addition, in an embodiment, the client application can access other BOM and FOTOBOM images stored on the server and retrieve the same in case the same are required for any processing step. FIG. 23 depicts a flow diagram of the communication between a user, client device and server as per the above embodiment. As shown in FIG. 23, 2301, 2302 and 2303 represent the mobile/client device display, FOTOBOM Client application and FOTOBOM server respectively. The user input provided through the mobile display is shown as 2304. Steps 2305 and 2306 represents the pre-processing and post processing steps taking place at the client application. As illustrated in FIG. 23, when the user selects the image, the client application displays the image on the mobile display 2301 for receiving user input on the same and in the background it is also conducting image processing shown as pre-processing steps 2305. In an embodiment, at the pre-processing stage, the client application normalizes the image to make it compatible with the system requirements. Once the user submits an input, the client application processes the image based on the user input and displays the final image on the mobile display 2301 for user reference. In an embodiment, the steps that the client application performs on the image after receiving the user inputs are shown as post processing steps 2306 as depicted in FIG. 23. Usually, the post processing steps would comprise creating a BOM or a FOTOBOM from the target image in accordance with the user instructions. In an embodiment, the post processing steps also comprise further normalization and alignment of the image to make it more compatible. In an embodiment, after creating the final image and sending it to the mobile display 2301 as illustrated in FIG. 23, the client application transfers the final processed image, which might be a BOM or a FOTOBOM image, to the FOTOBOM server for storage. In an embodiment, the transferred image is stored in the FOTOBOM server in a specific library/category under the user account. The above embodiment provides an enhanced user experience especially if the speed of internet connectivity is slow as the user device interacts minimally with the FOTOBOM server during image processing.

In an embodiment, the above described method also makes it possible for the user to remotely create BOM or FOTOBOM images while the client device is not connected with the server. In another embodiment, when the user device connects with the FOTOBOM server, the data corresponding to a user account stored on the client application synchronizes with the data stored on the server corresponding to that user such that any modifications done remotely through the client application are updated on the server. In an embodiment, in order to optimize the system performance, it is imperative that images (TARGETS and BOMS) in their normalized formats are stored on the server as much as possible. Storage on the service provides the following benefits:
1. Client application can send the location of image rather than the image itself which will reduce the amount of data needed to be transferred back and forth;
2. Client application can send metadata detailing the location of a BOM (or multiple BOMs) on the TARGET so that the server can construct the FOTOBOM from this metadata information which again will reduce the amount of data to be transferred;
3. The server can store the components of the FOTOBOM (original TARGET image+BOM images+metadata) to construct or deconstruct the FOTOBOM later;
4. The server can store, within the metadata, time stamping information which will show the “history” of a constructed FOTOBOM.

In an embodiment, the metadata information related to FOTOBOMS that is stored in the server includes: name and/or location of TARGET image; properties of TARGET image (width, height, other); name and/or location of BOM image; properties of BOM image (width, height, other); location of BOM image within a TARGET image; timestamp of BOM placement within a TARGET image; username of person who placed the BOM;

In another embodiment, the metadata information contains multiple image locations, positions and timestamps to recreate FOTOBOM images at different places in time.

In an embodiment, the application allows the users to create a “Special BOM” which could be used as a watermark on all the images created by the users. Many users want to sign/mark their creations and they can place this “Special BOM” on their work. In an embodiment, this “Special BOM” is designed by the users using standard templates.

One of ordinary skill in the art can appreciate that there could be multiple formats or types of file systems which can be used to create and store the BOM or FOTOBOM images described in above embodiments. The methods described in the present specification are not limited to any specific file type.

The above examples are merely illustrative of the many applications of the methods of present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

In the description and claims of the application, each of the words “comprise” “include” and “have”, and forms thereof, are not necessarily limited to members in a list with which the words may be associated.

We claim:

1. A method for processing a video file and posting said processed video file to an on-line social network, comprising:
selecting a reference frame from said video file;
receiving a user instruction identifying sections in said reference frame which are to be retained or removed from the video file;
modifying said reference frame based on said user instruction;
analyzing a plurality of other frames in the video file to identify similar frames comprising sections similar to the sections identified by the user in said reference frame;
modifying all similar frames based on the user instruction; and
creating a new video file comprising the modified frames, wherein said video processing is performed according to instructions input by a user via an application running on a mobile device.

2. The method according to claim 1, wherein said user instruction identifying sections in said reference frame which are to be retained or removed from the video file is performed by physically touching a portion of a screen of a mobile device, said portion of the screen being associated with pixels of the reference frame which are to be retained or removed from the video file.

3. The method according to claim 1, wherein the process of analyzing the plurality of other frames in the video file to identify frames comprising sections similar to the sections identified by the user in said reference frame is performed by comparing the pixels of the reference frame which are to be retained or removed from the video file with pixels of the plurality of other frames in the video file and identifying those pixels of the plurality of other frames in the video file having similar characteristics to the pixels of the reference frame which are to be retained or removed from the video file.

4. The method according to claim 1 wherein said video file comprises a plurality of frames in sequential order and wherein the reference frame is a first frame in said sequential order.

5. The method according to claim 1, wherein said video file is converted to an animated .GIF format before processing.

6. The method according to claim 1, wherein said video file is preprocessed to normalize it as per a requirement of a computer application executing said method.

7. The method according to claim 6, wherein said preprocessing comprises at least one of a) modifying a length of the video file, b) modifying a number of frames per second in said video file, c) modifying a resolution of said video file, and d) modifying a format of said video file.

8. The method according to claim 1, wherein said method is executed on the mobile device.

9. The method according to claim 1, wherein at least one of the steps of said method is executed at a remote server location.

10. The method according to claim 1, wherein sections removed from frames of said video file are replaced with at least one new image in such frames.

11. The method according to claim 10, wherein an edge detection process is used to identify start and end points of said sections.

12. The method according to claim 11, wherein the new video file is stored in a video gallery located at a client device or at a remote server location.

13. The method according to claim 1, further comprising sharing the new video file with other users of the on-line social network.

14. The method according to claim 1, wherein metadata related to the new video file is stored at a remote server location.

15. The method according to claim 14, wherein said metadata comprises at least one of a) a field describing a name of the new video file, b) a field describing a location of the new video file, c) a field describing properties of the new video file, d) a field describing a size of the new video file, e) a field describing a resolution of the new video file, f) a field describing a creation time stamp of the new video file, and g) a field describing a name of the user who created the new video file.

16. The method according to claim 1, further comprising providing a virtual keyboard embedded in said computer application.

17. The method according to claim 16, wherein said virtual keyboard is customized for each user and is updated based on the new video file.

18. The method according to claim 17, wherein said virtual keyboard of a first user is shareable with a plurality of other users.

19. The method according to claim 17, wherein said modified reference frame is stored in said virtual keyboard.

20. A method for processing video files to be shared in an on-line social network, comprising:
selecting a reference frame in said input video file;
receiving user instructions for identifying specific section in said reference frame;
modifying said reference frame by superimposing a new image over said identified section;
analyzing other frames in the video file to identify relevant frames comprising sections similar to the specific section identified by the user in said reference frame;
modifying all relevant frames by superimposing said new image on said specific sections in said relevant frames; and
creating a new video file comprising the modified frames;
wherein said video processing is performed according to instructions input by a user via an application running on a mobile device.
